(19) United States
(12) Patent Application Publication
(10) Pub. No.: US 2019/0309447 A1
(43) Pub. Date: Oct. 10, 2019

(54) PROCESS OF MAKING MULTICOMPONENT FIBERS

(71) Applicant: Eastman Chemical Company, Kingsport, TN (US)

(72) Inventors: Edgar N. Rudisill, Johnson City, TN (US); Richard Moore Holbert, JR., Kingsport, TN (US); Loady Palmer Holbrook, JR., Kingsport, TN (US); Johnathan Wayne Smith, Round Rock, TX (US); Kevin Leonard Urman, Church Hill, TN (US)

(73) Assignee: Eastman Chemical Company, Kingsport, TN (US)

(21) Appl. No.: 16/373,070

(22) Filed: Apr. 2, 2019

Related U.S. Application Data
(60) Provisional application No. 62/654,938, filed on Apr. 9, 2018.
(60) Provisional application No. 62/783,335, filed on Dec. 21, 2018.
(60) Provisional application No. 62/783,339, filed on Dec. 21, 2018.
(60) Provisional application No. 62/783,358, filed on Dec. 21, 2018.
(60) Provisional application No. 62/783,364, filed on Dec. 21, 2018.
(60) Provisional application No. 62/783,348, filed on Dec. 21, 2018.

(51) Int. Cl. D01F 8/14; D01D 5/08; C08L 67/02

(52) U.S. Cl. CPC D01F 8/14; D01D 5/08; C08L 2205/025; C08L 67/025; C08L 67/02

(57) ABSTRACT

A process for making a multicomponent fiber is disclosed. The process comprises extruding at least one water dispersible polymer to create a first polymer flow, extruding at least one water non-dispersible synthetic polymer to create a second polymer flow path, directing the resulting multiple polymer flows into a spinneret having a shaped cross section with a plurality of distribution flow paths, and combining the flow paths together to form a multicomponent fiber having a shaped cross section, wherein the multicomponent fiber comprises: (A) at least one water dispersible polymer; and (B) a plurality of domains comprising one or more water non-dispersible polymers, wherein the domains are substantially isolated from each other by the water dispersible polymer intervening between the domains; and wherein the water dispersible polymer is present at the perimeter of the outside cross-section of the multicomponent fiber in a proportion of no greater than 55% water dispersible polymer.

### CROSS REFERENCES TO RELATED APPLICATIONS

This application is an original application claiming priority to the U.S. Provisional Application 62/654,938 filed on Apr. 9th, 2018, U.S. Provisional Application 62/783,335 filed on Dec. 21st, 2018, U.S. Provisional Application 62/783,339 filed on Dec. 21st, 2018, U.S. Provisional Application 62/783,358 filed on Dec. 21st, 2018, U.S. Provisional Application 62/783,364 filed on Dec. 21st, 2018, and U.S. Provisional Application 62/783,348 filed on Dec. 21st, 2018. The foregoing applications are hereby incorporated by reference to the extent they do not contradict the statements herein.

### FIELD OF THE INVENTION

The present invention pertains to multicomponent fibers comprising at least one water non-dispersible synthetic polymer and at least one water dispersible polymer; wherein the water dispersible polymer is present at the perimeter of the outside cross-section of the multicomponent fiber in a proportion of no greater than 55% water dispersible polymer. Articles comprising the multicomponent fibers are also provided, as well as, processes for making the multicomponent fibers, texturing the multicomponent fibers, and producing various fabrics comprising the multicomponent fibers.

### BACKGROUND

The value of low denier filament (microfibers) for the textile industry for specialty performance products is well known. The production of such low denier filament is challenging due to the handling of the very small fibers. One method used to circumvent this challenge is to produce multicomponent fibers where a larger fiber is produced and formed into a textile and then part of that multicomponent fiber is removed in a secondary process that leaves only the small fibers in the textile product. In this invention, an improvement is made to this multicomponent approach where the multicomponent fibers comprising the yarn are designed such that the removable component, which is water soluble or water dispersible, is present at the perimeter of the outside cross-section of the multicomponent fiber in a proportion of no greater than 55% water dispersible polymer. This improved multicomponent fiber has better performance in downstream process steps and is more robust in the spinning and handling operations.

### SUMMARY

In one embodiment of the present invention, there is provided a multicomponent fiber having a shaped cross section, said multicomponent fiber comprising:
(A) at least one water dispersible polymer; and
(B) a plurality of domains comprising one or more water non-dispersible polymers, wherein the domains are substantially isolated from each other by the water dispersible polymer intervening between the domains; and
   wherein the water dispersible polymer is present at the perimeter of the outside cross-section of the multicomponent fiber in a proportion of no greater than 55% water dispersible polymer.

In another embodiment of the invention, there is provided a multicomponent fiber having a shaped cross section, said multicomponent fiber comprising:
(A) at least one water dispersible polymer; and
(B) a plurality of domains comprising one or more water non-dispersible polymers, wherein said domains are substantially isolated from each other by said water dispersible polymer intervening between said domains; and wherein said water dispersible polymer is present at the perimeter of the outside cross-section of said multicomponent fiber in a proportion of not greater than 25% water dispersible polymer.

Articles produced from the multicomponent fiber are also provided, including wovens and nonwovens.

In another embodiment of this invention, a process of making a multicomponent fiber is provided. The process comprises spinning a multicomponent fiber having a shaped cross section, the multicomponent fiber comprising:
(A) at least one water dispersible polymer; and
(B) a plurality of domains comprising one or more water non-dispersible polymers, wherein the domains are substantially isolated from each other by the water dispersible polymer intervening between the domains; and

wherein the water dispersible polymer is present at the perimeter of the outside cross-section of the multicomponent fiber in a proportion of no greater than 55% water dispersible polymer.

In another embodiment, a process for texturing a multicomponent fiber having a shaped cross section is provided. The process comprises: (A) providing a multicomponent fiber having a shaped cross section and at least one water dispersible polymer; and a plurality of domains comprising one or more water non-dispersible polymers, wherein said domains are substantially isolated from each other by said water dispersible polymer intervening between said domains; and (B) passing the multicomponent fiber through a first zone comprising a first heating device and a twisting unit, wherein the first heating device has a heating temperature that is at least 10% less than the temperature used for a fiber without the water dispersible component having the same water non-dispersible polymer, same number of total filaments in the fiber, and the same total denier for a given type of equipment and process conditions.

In another embodiment of the invention, a process for texturing a multicomponent fiber having a shaped cross section is provided. The process comprises: (A) providing a multicomponent fiber having a shaped cross section and at least one water dispersible polymer; and a plurality of domains comprising one or more water non-dispersible polymers, wherein said domains are substantially isolated from each other by said water dispersible polymer intervening between said domains; and (B) passing the multicomponent fiber through a first zone comprising a heating device, a twisting unit and a cooling zone, wherein the step of passing the multicomponent fiber through a first zone comprises heating the multicomponent fiber, providing a twist to the multicomponent fiber and cooling the multicomponent fiber, and wherein the first heating device has a heating temperature that is at least 10% less than the temperature used for a fiber without the water dispersible component having the same water non-dispersible polymer, same number of total filaments in the fiber, and the same total denier for a given type of equipment and process conditions; and (C) optionally, passing the fiber through a second zone, wherein the second zone comprises a second heating device.

In another embodiment of the invention, a process for texturing a fiber is provided. The process comprises: (A) providing a first fiber, wherein the first fiber is a multicomponent fiber having a shaped cross section and at least one water dispersible polymer; and a plurality of domains comprising one or more water non-dispersible polymers, wherein said domains are substantially isolated from each other by said water dispersible polymer intervening between said domains; (B) providing a second fiber; (C) passing the first fiber through a first processing zone, wherein the first processing zone comprises a heating device and a twisting zone, wherein the first fiber is heated, wherein the heating temperature of the first heating device is at least 10% less than the temperature used for a fiber without the water dispersible component having the same water non-dispersible polymer, same number of total filaments in the fiber, and the same total denier for a given type of equipment and process conditions, wherein the twisting zone comprises at least one friction disk; (D) passing the second fiber through a second processing zone, wherein the second processing zone comprises a heating device and a twisting zone wherein the second fiber is heated; and (E) combining the first fiber and the second fiber to make a yarn comprising the multicomponent fiber having a shaped cross section and at least one water dispersible polymer and the second fiber.

In another embodiment, a process for texturing a multicomponent fiber having a shaped cross section is provided. The process comprises: (A) providing a multicomponent fiber having a shaped cross section and at least one water dispersible polymer; and a plurality of domains comprising one or more water non-dispersible polymers, wherein said domains are substantially isolated from each other by said water dispersible polymer intervening between said domains; and wherein the water dispersible polymer is present at the perimeter of the outside cross-section of the multicomponent fiber in a proportion of no greater than 55% water dispersible polymer; and (B) passing the multicomponent fiber through a first zone comprising a first heating device and a twisting unit, wherein the first heating device has a heating temperature that is at least 10% less than the temperature used for a fiber without the water dispersible component having the same water non-dispersible polymer, same number of total filaments in the fiber, and the same total denier for a given type of equipment and process conditions.

In another embodiment of the invention, a process for texturing a multicomponent fiber having a shaped cross section is provided. The process comprises: (A) providing a multicomponent fiber having a shaped cross section and at least one water dispersible polymer; and a plurality of domains comprising one or more water non-dispersible polymers, wherein said domains are substantially isolated from each other by said water dispersible polymer intervening between said domains; and wherein the water dispersible polymer is present at the perimeter of the outside cross-section of the multicomponent fiber in a proportion of no greater than 55% water dispersible polymer; and (B) passing the multicomponent fiber through a first zone comprising a heating device, a twisting unit and a cooling zone, wherein the step of passing the multicomponent fiber through a first zone comprises heating the multicomponent fiber, providing a twist to the multicomponent fiber and cooling the multicomponent fiber, and wherein the first heating device has a heating temperature that is at least 10% less than the temperature used for a fiber without the water dispersible component having the same water non-dispersible polymer, same number of total filaments in the fiber, and the same total denier for a given type of equipment and process conditions; and (C) optionally, passing the fiber through a second zone, wherein the second zone comprises a second heating device.

In another embodiment of the invention, a process for texturing a fiber is provided. The process comprises: (A) providing a first fiber, wherein the first fiber is a multicomponent fiber having a shaped cross section and at least one water dispersible polymer; and a plurality of domains comprising one or more water non-dispersible polymers, wherein said domains are substantially isolated from each other by said water dispersible polymer intervening between said domains; and wherein the water dispersible polymer is present at the perimeter of the outside cross-section of the multicomponent fiber in a proportion of no greater than 55% water dispersible polymer; (B) providing a second fiber; (C) passing the first fiber through a first processing zone, wherein the first processing zone comprises a heating device and a twisting zone, wherein the first fiber is heated, wherein the heating temperature of the first heating device is at least 10% less than the temperature used for a fiber without the water dispersible component having the same water non-dispersible polymer, same number of total filaments in the fiber, and the same total denier for a given type of equipment and process conditions, wherein the twisting zone comprises at least one friction disk; (D) passing the second fiber through a second processing zone, wherein the second processing zone comprises a heating device and a twisting zone wherein the second fiber is heated; and (E) combining the first fiber and the second fiber to make a yarn comprising the multicomponent fiber having a shaped cross section and at least one water dispersible polymer and the second fiber.

In another embodiment of the present invention, a process is provided for producing a fabric. The process comprises: 1) providing a plurality of multicomponent fibers; wherein the multicomponent fiber comprises at least one water non-dispersible synthetic polymer and at least one water dispersible polymer, wherein said multicomponent fiber has water dispersible polymer segments and water non-dispersible synthetic polymer segments; wherein the water dispersible polymer is present at the perimeter of the outside cross-section of the multicomponent fiber in a proportion of no greater than about 55% water dispersible polymer; and 2) weaving, knitting, and/or braiding the multicomponent fiber to produce the fabric.

### BRIEF DESCRIPTION OF THE FIGURES

Embodiments of the present invention are described herein with reference to the following drawing figures, wherein:

FIG. 1 is a comparative multicomponent fiber cross-section having a ribbon or striped configuration with 5 water non-dispersible synthetic polymer stripes and 6 water dispersible polymer stripes where the water dispersible polymer stripes are on the outer perimeter. The water non-dispersible polymer is polyethylene terephthalate (PET), and the water dispersible polymer is sulfopolyester (5 Stripe PET Multicomponent Fiber). This comparative multicomponent fiber has 56.5% sulfopolyester on the perimeter of the multicomponent fiber surface cross-section.

FIG. 2 is an embodiment of the inventive multicomponent fiber having a ribbon or striped configuration with 6 water non-dispersible synthetic polymer stripes and 5 water dispersible polymer stripes. The water non-dispersible synthetic polymer stripes are on the outer perimeter. This multicomponent fiber has 17.6% water dispersible polymer at the perimenter of the multicomponent fiber surface cross-section. In one embodiment, the water non-dispersible polymer is polyethylene terephthalate (PET), and the water dispersible polymer is sulfopolyester (6 Stripe PET Multicomponent Fiber). This multicomponent fiber has 17.6% sulfopolyester at the perimeter of the multicomponent fiber surface cross-section.

FIG. 3 is an embodiment of the inventive multicomponent fiber having a segmented pie configuration with 16 segments with alternating segments of water dispersible polymer and water non-dispersible synthetic polymer. The water dispersible polymer segments are smaller than the water non-dispersible synthetic polymer such that the water dispersible polymer at the perimeter of the multicomponent fiber surface cross-section is about 21.6% water dispersible.

FIG. 4 is an embodiment of the inventive multicomponent fiber having a segmented pie configuration with 32 segments with alternating segments of water dispersible polymer and water non-dispersible synthetic polymer. The water dispersible polymer segments are smaller than the water non-dispersible synthetic polymer such that the water dispersible polymer at the perimeter of the multicomponent fiber surface cross-section is about 21.6% water dispersible.

FIG. 5. is a figure showing the various types of textured fibers or yarns. In FIG. 5(a), the textured fibers or yarns are curled. In FIG. 5(b), the textured fibers or yarns are high bulk (stretched and relaxed principle). In FIG. 5(c), the textured fibers or yarns have a lofted effect from the use of air jet. In FIG. 5(d), the textured fibers or yarns are stretch core texturized, which can retain good elasticity. In FIG. 5(e), the textured fibers or yarns have a synfoam texturizing (twist and untwist method). In FIG. 5(f), the textured fibers or yarns have a peaked crimp effect. In FIG. 5(g), the textured fibers or yarns have a rounded crimp effect. In FIG. 5(h), heated gears provide the crimp to the fibers or yarns. In FIG. 5(i), the textured fibers or yarns have been produced by a stuffing box method. In FIG. 5(j), the textured fiber or yarn is produced with high twist but not highly elastic. In FIG. 5(k), the textured fiber or yarn is coiled.

FIG. 6 is a graph comparing the thickness of an example of double knit yarn of the invention compared to a fully drawn yarn of the same type.

FIG. 7 is a graph comparing the thickness of an example of single knit yarn of the invention compared to a fully drawn yarn of the same type.

FIG. 8A is a picture taken at 500× power of an example of double knit fully drawn yarn.

FIG. 8B is a picture taken at 500× power of an example of double knit textured yarn of the invention.

FIG. 9A is a picture taken at 500× power of an example of single knit fully drawn yarn.

FIG. 9B is a picture taken at 500× power of an example of single knit textured yarn of the invention.

FIG. 10A is a picture taken at 100× power of an example of double knit fully drawn yarn.

FIG. 10B is a picture taken at 100× power of an example of double knit textured yarn of the invention.

FIG. 11A is a picture taken at 100× power of an example of single knit fully drawn yarn.

FIG. 11B is a picture taken at 100× power of an example of single knit textured yarn of the invention.

FIG. 12 is a diagram showing a friction disk draw texturing process.

### DETAILED DESCRIPTION

The present invention provides a multicomponent fiber having a shaped cross section, the multicomponent fiber comprising: (A) at least one water dispersible polymer; and (B) a plurality of domains comprising one or more water non-dispersible polymers, wherein the domains are substantially isolated from each other by the water dispersible polymer intervening between the domains; and wherein the water dispersible polymer is present at the perimeter of the outside cross-section of the multicomponent fiber in a proportion of no greater than 55%. The present invention also provides a process for texturing a multicomponent fiber having a shaped cross section.

The term “multicomponent fiber” as used herein, is intended to mean a fiber or filament prepared by melting at least two or more fiber-forming polymers in separate extruders, directing the resulting multiple polymer flows into one spinneret with a plurality of distribution flow paths, and spinning the flow paths together to form one fiber. Multicomponent fibers are also sometimes referred to as conjugate or bicomponent fibers. The polymers are arranged in distinct segments or configurations across the cross-section of the multicomponent fibers and extend continuously along the length of the multicomponent fibers. The configurations of such multicomponent fibers may include, for example, eccentric sheath core, side by side, segmented pie, striped (ribbon), or islands-in-the-sea. For example, a multicomponent fiber may be prepared by extruding a water dispersible sulfopolyester and one or more water non-dispersible synthetic polymers separately through a spinneret having a shaped or engineered transverse geometry such as, for example, a striped configuration.

The terms “segment,” and/or “domain,” when used to describe the shaped cross section of a multicomponent fiber refer to the area within the cross section comprising the water non-dispersible synthetic polymers. These domains or segments are substantially isolated from each other by the water-dispersible polymer, which intervenes between the segments or domains. The term “substantially isolated,” as used herein, is intended to mean that the segments or domains are set apart from each other to permit the segments or domains to form individual fibers upon removal of the water dispersible polymer. Segments or domains can be of similar shape and size or can vary in shape and/or size. Furthermore, the segments or domains can be “substantially continuous” along the length of the multicomponent fiber. The term “substantially continuous” means that the segments or domains are continuous along at least 10 cm length of the multicomponent fiber. In one embodiment of the invention, these segments or domains of the multicomponent fiber produce the ribbon fibers when the water dispersible polymer is removed.

The term “water-dispersible,” as used in reference to the water-dispersible component of the water dispersible polymer (e.g. sulfopolyesters) is intended to be synonymous with the terms “water-dissipatable,” “water-disintegratable,” “water-dissolvable,” “water-dispellable,” “water soluble,” “water-removable,” “hydrosoluble,” and “hydrodispersible” and is intended to mean that the water dispersible polymer component is sufficiently removed from the multicomponent fiber and is dispersed and/or dissolved by the action of water to enable the release and separation of the water non-dispersible fibers contained therein. The terms “dispersed,” “dispersible,” “dissipate,” or “dissipatable” mean that, when using a sufficient amount of deionized water (e.g., 100:1 water:fiber by weight) to form a loose suspension or slurry of the water dispersible polymer fibers at a temperature of about 60° C., and within a time period of up to 5 days, the water dispersible polymer component dissolves, disintegrates, or separates from the multicomponent fiber, thus leaving behind a plurality of ribbon fibers from the water non-dispersible segments.

In the context of this invention, all of these terms refer to the activity of water or a mixture of water and a water-miscible cosolvent on the water dispersible polymer described herein. Examples of such water-miscible cosolvents includes alcohols, ketones, glycol ethers, esters and the like. It is intended for this terminology to include conditions where the water dispersible polymer is dissolved to form a true solution as well as those where the water dispersible polymer is dispersed within the aqueous medium. When the water dispersible polymer is a sulfopolyester, due to the statistical nature of sulfopolyester compositions, it is possible to have a soluble fraction and a dispersed fraction when a single sulfopolyester sample is placed in an aqueous medium.

The term “polyester”, as used herein, encompasses both “homopolyesters” and “copolyesters” and means a synthetic polymer prepared by the polycondensation of difunctional carboxylic acids with a difunctional hydroxyl compound. Typically, the difunctional carboxylic acid is a dicarboxylic acid and the difunctional hydroxyl compound is a dihydric alcohol such as, for example, glycols and diols. Alternatively, the difunctional carboxylic acid may be a hydroxy carboxylic acid such as, for example, p-hydroxybenzoic acid, and the difunctional hydroxyl compound may be an aromatic nucleus bearing two hydroxy substituents such as, for example, hydroquinone. As used herein, the term “sulfopolyester” means any polyester comprising a sulfomonomer. The term “residue,” as used herein, means any organic structure incorporated into a polymer through a polycondensation reaction involving the corresponding monomer. Thus, the dicarboxylic acid residue may be derived from a dicarboxylic acid monomer or its associated acid halides, esters, salts, anhydrides, or mixtures thereof. Therefore, the term dicarboxylic acid is intended to include dicarboxylic acids and any derivative of a dicarboxylic acid, including its associated acid halides, esters, half-esters, salts, half-salts, anhydrides, mixed anhydrides, or mixtures thereof, useful in a polycondensation process with a diol to make high molecular weight polyesters.

The water dispersible polymer of this invention can be any that is known in the art. Water dispersible polymers include, but are not limited to, sulfopolyesters, polyvinyl alcohols, acrylics, polyethylene glycols, polyvinyl methyl ethers, polyethyleneimines, polyquaternary amines, polymers of ethylene oxide, starches, and modified cellulosics. Examples of acrylics include, but are not limited to, ethylene-acrylic acid copolymers, and polyacrylic or methacrylic acid copolymers. An example of modified cellulose is hydroxyl ethyl cellulose.

In one embodiment of the invention, the water dispersible polymer is a water dispersible sulfopolyester. The water dispersible sulfopolyesters generally comprise dicarboxylic acid monomer residues, sulfomonomer residues, diol monomer residues, and repeating units. The sulfomonomer may be a dicarboxylic acid, a diol, or hydroxycarboxylic acid. The term “monomer residue,” as used herein, means a residue of a dicarboxylic acid, a diol, or a hydroxycarboxylic acid. A “repeating unit,” as used herein, means an organic structure having 2 monomer residues bonded through a carbonyloxy group. The sulfopolyesters of the present invention contain substantially equal molar proportions of acid residues (100 mole percent) and diol residues (100 mole percent), which react in substantially equal proportions such that the total moles of repeating units is equal to 100 mole percent. The mole percentages provided in the present disclosure, therefore, may be based on the total moles of acid residues, the total moles of diol residues, or the total moles of repeating units. For example, a sulfopolyester containing 30 mole percent of a sulfomonomer, which may be a dicarboxylic acid, a diol, or hydroxycarboxylic acid, based on the total repeating units, means that the sulfopolyester contains 30 mole percent sulfomonomer out of a total of 100 mole percent repeating units. Thus, there are 30 moles of sulfomonomer residues among every 100 moles of repeating units. Similarly, a sulfopolyester containing 30 mole percent of a sulfonated dicarboxylic acid, based on the total acid residues, means the sulfopolyester contains 30 mole percent sulfonated dicarboxylic acid out of a total of 100 mole percent acid residues. Thus, in this latter case, there are 30 moles of sulfonated dicarboxylic acid residues among every 100 moles of acid residues.

While including a water dispersible polymer component in a multicomponent fiber design is desirable since it can be removed in an aqueous process to leave behind very small water non-dispersible polymer fibers, other properties of the water dispersible polymer can create processing issues both in multicomponent fiber production, multicomponent fiber storage, and the performance of the multicomponent fiber in downstream processing. Typically, the water dispersible polymer component in the fiber will comprise a significant percentage of the multicomponent fiber surface (perimeter) due to typical cross section designs or the intent to promote easy dissolution of the water dispersible polymer component. It has been found in this invention that the amount of water dispersible polymer should be reduced at the surface of the multicomponent fiber. This reduction creates a multicomponent fiber that is more robust both in terms of spin processing and downstream processing. For example, multicomponent fibers with greater than 55% water dispersible polymer at the perimeter can experience the following processing problems: 1) increased unwind tension as a function of storage conditions; 2) high friction in downstream processing equipment resulting in wear on the equipment components; 3) sensitivity to finish composition; 4) poor performance in spin process configurations; and 5) post processing of multicomponent fiber yarn.

In this invention, the water dispersible polymer is present at the perimeter of the outside cross-section of the multicomponent fiber of this invention in a proportion of no greater than about 55% water dispersible polymer. In other embodiments of this invention, the perimeter of the outside cross-section of the multicomponent fiber has a proportion of water dispersible polymer no greater than about 54%, 53%, 52%, 51%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4%, 3%, 2%, or 1%.

In another embodiment of this invention, the amount of water dispersible polymer at the perimeter of the multicomponent fiber can range from about 1% to about 55%, about 5% to about 53%, about 5% to about 50%, about 5% to about 45%, about 5% to 50%, about 5% to about 40%, about 7% to about 35%, about 7% to about 30%, about 7% to about 25%, about 8% to about 23%, about 9% to about 22%, about 10% to about 21%, about 11% to about 20%, about 12% to about 19%, and about 13% to about 18%. The percentage of water dispersible polymer at the perimeter of the multicomponent fiber can be measured by taking an image of the cross-section of the multicomponent fiber and measuring the length of the perimeter comprising water dispersible polymer. After determining this length, it is divided by the total perimeter of the multicomponent fiber.

In one embodiment of the invention, the multicomponent fiber has the striped or ribbon cross-section as shown in FIG. 2. It contains 11 stripes with the outer stripes being water non-dispersible synthetic polymer. It contains 6 stripes of water non-dispersible synthetic polymer, and 5 narrow stripes of water dispersible polymer. In one embodiment, the water dispersible polymer is sulfopolyester, and the water non-dispersible polymer is polyethylene terephthalate (PET).

In another embodiment, the multicomponent fiber has a segmented pie configuration as shown in FIGS. 3 and 4. In FIG. 3, the multicomponent fiber has 16 segments with 8 water dispersible polymer domains separating 8 water non-dispersible domains. In FIG. 4, the multicomponent fiber has 32 segments with 16 water dispersible polymer domains separating 16 water non-dispersible domains. In both of these figures, the water dispersible polymer present at the perimeter of the outside cross-section of the multicomponent fiberis 21.6%.

The multicomponent fiber can be cut into any length that can be utilized to produce any article known in the art. Such articles include, but are not limited to, nonwoven articles or staple spun yarns. In one embodiment the multicomponent fiber is cut to produce staple fiber. As used herein, a “staple fiber” refers to a fiber having discrete length. Generally, the staple fibers can have a cut length of 0.1 millimeter (mm) to 100 mm; however, a cut length of 3 mm to 10 mm is generally preferred. In one embodiment of the invention, the multicomponent fiber is cut into lengths ranging from at least 0.1, 0.25, or 0.5 millimeter and/or not more than 25, 10, 5, or 2 millimeters. For staple spun yarns, the multicomponent fiber can be cut into staple fiber having a cut length ranging from 20 mm to 100 mm. In one embodiment, the cutting ensures a consistent fiber length so that at least 75, 85, 90, 95, or 98 percent of the individual fibers have an individual length that is within 90, 95, or 98 percent of the average length of all fibers.

In addition, our invention also provides a process for producing the multicomponent fibers and the microfibers derived therefrom, the process comprises (a) producing the multicomponent fiber and (b) generating the microfibers from the multicomponent fibers.

The process to produce the multicomponent fiber comprises spinning at least one water dispersible polymer and at least one water non-dispersible synthetic polymer to produce a multicomponent fiber. In one embodiment, the process begins by (a) spinning a water dispersible sulfopolyester having a glass transition temperature (Tg) of at least 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., or 65° C. and one or more water non-dispersible synthetic polymers. The multicomponent fibers can have a plurality of segments comprising the water non-dispersible synthetic polymers that are substantially isolated from each other by the sulfopolyester, which intervenes between the segments. The sulfopolyester can comprise:

(i) about 50 to about 96 mole percent of one or more residues of isophthalic acid and/or terephthalic acid, based on the total acid residues;

(ii) about 4 to about 30 mole percent, based on the total acid residues, of a residue of sodiosulfoisophthalic acid;

(iii) one or more diol residues, wherein at least 25 mole percent, based on the total diol residues, is a poly(ethylene glycol) having a structure H—(OCH₂—CH₂)ₙ—OH wherein n is an integer in the range of 2 to about 500; and

(iv) 0 to about 20 mole percent, based on the total repeating units, of residues of a branching monomer having 3 or more functional groups wherein the functional groups are hydroxyl, carboxyl, or a combination thereof. Ideally, the sulfopolyester has a melt viscosity of less than 12,000, 8,000, or 6,000 poise measured at 240° C. at a strain rate of 1 rad/sec.

The microfibers are generated by (b) contacting the multicomponent fibers with water to remove the water dispersible polymer thereby forming the microfibers comprising the water non-dispersible synthetic polymer. When the water dispersible polymer is a sulfopolyester for nonwoven applications, typically, the multicomponent fiber is contacted with water at a temperature of about 25° C. to about 100° C., or at a temperature of about 50° C. to about 80° C., for a time period of from about 10 to about 600 seconds whereby the sulfopolyester is dissipated or dissolved. In woven, knit, or braided applications, the multicomponent fiber is contacted with water at a temperature of about 25° C. to about 150° C., from about 50° C. to about 150° C., from about 80° C. to about 150° C., or from about 80° C. to about 130° C.

The ratio by weight of the water dispersible polymer to the water non-dispersible synthetic polymer component in the multicomponent fiber of the invention is generally in the range of about 98:2 to about 2:98 or, in another example, in the range of about 25:75 to about 75:25. In another embodiment of this invention, the ratio by weight of the water dispersible polymer to water non-dispersible synthetic polymer component in the multicomponent fiber of the invention is in the ratio of about 90:10 Typically, the water dispersible polymercomprises 50 percent by weight or less, 40 percent by weight or less, 30 percent by weight or less, 20 percent by weight or less of the total weight of the multicomponent fiber. In one embodiment of the invention, the water dispersible polymer is sulfopolyester.

A process is also provided to produce a woven, knitted, or braided article or fabric comprising the inventive multicomponent fiber. The multicomponent fiber can be woven, knitted, or braided with any other fiber known in the art. After the article or fabric is woven, knitted, or braided, the article or fabric is contacted with water to remove the water dispersible polymer.

In another embodiment of this invention, the multicomponent fiber can be cut into any length depending on the end use application. In one embodiment, the multicomponent is cut to produce a nonwoven media. The process comprises:

(a) cutting a multicomponent fiber into cut multicomponent fibers having a length of less than 100 millimeters;

(b) contacting a fiber-containing feedstock comprising the cut multicomponent fibers with a wash water for at least 0.1, 0.5, or 1 minutes and/or not more than 30, 20, or 10 minutes to produce a fiber mix slurry, wherein the wash water can have a pH of less than 10, 8, 7.5, or 7 and can be substantially free of added caustic;

(c) heating the fiber mix slurry to produce a heated fiber mix slurry;

(d) optionally, mixing the fiber mix slurry in a shearing zone;

(e) removing at least a portion of the sulfopolyester from the multicomponent fiber to produce a slurry mixture comprising a sulfopolyester dispersion and the microfibers;

(f) removing at least a portion of the sulfopolyester dispersion from the slurry mixture to thereby provide a wet lap comprising the microfibers, wherein the wet lap is comprised of at least 5, 10, 15, or 20 weight percent and/or not more than 70, 55, or 40 weight percent of the microfibers and at least 30, 45, or 60 weight percent and/or not more than 90, 85, or 80 weight percent of the sulfopolyester dispersion, wherein the sulfopolyester dispersion is an aqueous dispersion comprised of water and water dispersible sulfopolyesters; and

(g) combining the wet lap with a dilution liquid to produce a dilute wet-lay slurry or “fiber furnish” comprising the microfibers in an amount of at least 0.001, 0.005, or 0.01 weight percent and/or not more than 1, 0.5, or 0.1 weight percent to produce the nonwoven media.

In another embodiment of the invention, the wet lap is comprised of at least 5, 10, 15, or 20 weight percent and/or not more than 50, 45, or 40 weight percent of the water non-dispersible microfiber and at least 50, 55, or 60 weight percent and/or not more than 90, 85, or 80 weight percent of the sulfopolyester dispersion.

In addition, the wet lap can further comprise a fiber finishing composition comprising an oil, a wax, and/or a fatty acid. The fatty acid and/or oil used for the fiber finishing composition can be naturally-derived. In another embodiment, the fiber finishing composition comprises mineral oil, stearate esters, sorbitan esters, and/or neatsfoot oil. The fiber finishing composition can make up at least 10, 50, or 100 ppmw and/or not more than 5,000, 1000, or 500 ppmw of the wet lap.

The removal of the water-dispersible sulfopolyester can be determined by physical observation of the slurry mixture. The water utilized to rinse the fabric or article is clear if the water-dispersible sulfopolyester has been mostly removed. If the water dispersible sulfopolyester is still present in noticeable amounts, then the water utilized to rinse the fabric or article can be milky in color. Further, if water-dispersible sulfopolyester remains on the fabric or article, the fabric or article can be somewhat sticky to the touch.

In one embodiment of this invention, at least one water softening agent may be used to facilitate the removal of the water-dispersible sulfopolyester from the multicomponent fiber. Any water softening agent known in the art can be utilized. In one embodiment, the water softening agent is a chelating agent or calcium ion sequestrant. Applicable chelating agents or calcium ion sequestrants are compounds containing a plurality of carboxylic acid groups per molecule where the carboxylic groups in the molecular structure of the chelating agent are separated by 2 to 6 atoms. Tetrasodium ethylene diamine tetraacetic acid (EDTA) is an example of the most common chelating agent, containing four carboxylic acid moieties per molecular structure with a separation of 3 atoms between adjacent carboxylic acid groups. Sodium salts of maleic acid or succinic acid are examples of the most basic chelating agent compounds. Further examples of applicable chelating agents include compounds which have multiple carboxylic acid groups in the molecular structure wherein the carboxylic acid groups are separated by the required distance (2 to 6 atom units) which yield a favorable steric interaction with di- or multi-valent cations such as calcium which cause the chelating agent to preferentially bind to di- or multi valent cations. Such compounds include, for example, diethylenetriam inepentaacetic acid; diethylenetriam ine-N,N,N′, N′, N″-pentaacetic acid; pentetic acid; N,N-bis(2-(bis-(carboxymethyl)amino)ethyl)-glycine; diethylenetriamine pentaacetic acid; [[(carboxymethyl)imino]bis(ethylenenitrilo)]tetra-acetic acid; edetic acid; ethylenedinitrilotetraacetic acid; EDTA, free base; EDTA, free acid; ethylenediam ine-N, N, N′, N′-tetraacetic acid; ham pene; versene; N, N′-1,2-ethanediylbis-(N-(carboxymethyl)glycine); ethylenediamine tetra-acetic acid; N,N-bis(carboxymethyl)glycine; triglycollamic acid; trilone A; α,α′,α″-5 trimethylaminetricarboxylic acid; tri(carboxymethyl)amine; am inotriacetic acid; hampshire NTA acid; nitrilo-2,2′,2″-triacetic acid; titriplex i; nitrilotriacetic acid; and mixtures thereof.

The sulfopolyesters described herein can have an inherent viscosity, abbreviated hereinafter as “I.V.”, of at least about 0.1, 0.2, or 0.3 dL/g, preferably about 0.2 to 0.3 dL/g, and most preferably greater than about 0.3 dL/g, as measured in 60/40 parts by weight solution of phenol/tetrachloroethane solvent at 25° C. and at a concentration of about 0.5 g of sulfopolyester in 100 mL of solvent.

The sulfopolyesters of the present invention can include one or more dicarboxylic acid residues. Depending on the type and concentration of the sulfomonomer, the dicarboxylic acid residue may comprise at least 60, 65, or 70 mole percent and not more than 95 or 100 mole percent of the acid residues. Examples of dicarboxylic acids that may be used include aliphatic dicarboxylic acids, alicyclic dicarboxylic acids, aromatic dicarboxylic acids, or mixtures of two or more of these acids. Thus, suitable dicarboxylic acids include, but are not limited to, succinic, glutaric, adipic, azelaic, sebacic, fumaric, maleic, itaconic, 1,3-cyclohexanedicarboxylic, 1,4cyclohexanedicarboxylic, diglycolic, 2,5-norbornanedicarboxylic, phthalic, terephthalic, 1,4-naphthalenedicarboxylic, 2,5-naphthalenedicarboxylic, diphenic, 4,4′-oxydibenzoic, 4,4′-sulfonyidibenzoic, and isophthalic. The preferred dicarboxylic acid residues are isophthalic, terephthalic, and 1,4-cyclohexanedicarboxylic acids, or if diesters are used, dimethyl terephthalate, dimethyl isophthalate, and dimethyl-1,4-cyclohexanedicarboxylate with the residues of isophthalic and terephthalic acid being especially preferred. Although the dicarboxylic acid methyl ester is the most preferred embodiment, it is also acceptable to include higher order alkyl esters, such as ethyl, propyl, isopropyl, butyl, and so forth. In addition, aromatic esters, particularly phenyl, also may be employed.

The sulfopolyesters can include at least 4, 6, or 8 mole percent and not more than about 40, 35, 30, or 25 mole percent, based on the total repeating units, of residues of at least one sulfomonomer having 2 functional groups and one or more sulfonate groups attached to an aromatic or cycloaliphatic ring wherein the functional groups are hydroxyl, carboxyl, or a combination thereof. The sulfomonomer may be a dicarboxylic acid or ester thereof containing a sulfonate group, a diol containing a sulfonate group, or a hydroxy acid containing a sulfonate group. The term “sulfonate” refers to a salt of a sulfonic acid having the structure “—SO₃M,” wherein M is the cation of the sulfonate salt. The cation of the sulfonate salt may be a metal ion such as Li⁺, Na⁺, K⁺, and the like. When a monovalent alkali metal ion is used as the cation of the sulfonate salt, the resulting sulfopolyester is completely dispersible in water with the rate of dispersion dependent on the content of sulfomonomer in the polymer, temperature of the water, surface area/thickness of the sulfopolyester, and so forth. When a divalent metal ion is used, the resulting sulfopolyesters are not readily dispersed by cold water but are more easily dispersed by hot water. Utilization of more than one counterion within a single polymer composition is possible and may offer a means to tailor or fine-tune the water-responsivity of the resulting article of manufacture. Examples of sulfomonomer residues include monomer residues where the sulfonate salt group is attached to an aromatic acid nucleus, such as, for example, benzene, naphthalene, diphenyl, oxydiphenyl, sulfonyldiphenyl, methylenediphenyl, or cycloaliphatic rings (e.g., cyclopentyl, cyclobutyl, cycloheptyl, and cyclooctyl). Other examples of sulfomonomer residues which may be used in the present invention are the metal sulfonate salts of sulfophthalic acid, sulfoterephthalic acid, sulfoisophthalic acid, or combinations thereof. Other examples of sulfomonomers which may be used include 5-sodiosulfoisophthalic acid and esters thereof.

The sulfomonomers used in the preparation of the sulfopolyesters are known compounds and may be prepared using methods well known in the art. For example, sulfomonomers in which the sulfonate group is attached to an aromatic ring may be prepared by sulfonating the aromatic compound with oleum to obtain the corresponding sulfonic acid and followed by reaction with a metal oxide or base, for example, sodium acetate, to prepare the sulfonate salt. Procedures for preparation of various sulfomonomers are described, for example, in U.S. Pat. No. 3,779,993; U.S. Pat. No. 3,018,272; and U.S. Pat. No. 3,528,947, the disclosures of which are incorporated herein by reference.

The sulfopolyesters can include one or more diol residues which may include aliphatic, cycloaliphatic, and aralkyl glycols. The cycloaliphatic diols, for example, 1,3- and 1,4-cyclohexanedimethanol, may be present as their pure cis or trans isomers or as a mixture of cis and trans isomers. As used herein, the term “diol” is synonymous with the term “glycol” and can encompass any dihydric alcohol. Examples of diols include, but are not limited to, ethylene glycol, diethylene glycol, triethylene glycol, polyethylene glycols, 1,3-propanediol, 2,4-dimethyl-2-ethylhexane-1,3-diol, 2,2-dimethyl-1,3-propanediol, 2-ethyl-2-butyl-1,3-propanediol, 2-ethyl-2-isobutyl-1,3-propanediol, 1,3-butanediol, 1,4-butanediol, 1,5-pentanediol, 1,6-hexanediol, 2,2,4-trimethyl-1,6-hexanediol, thiodiethanol, 1,2-cyclohexanedimethanol, 1,3-cyclohexanedimethanol, 1,4-cyclohexanedimethanol, 2,2,4,4-tetramethyl-1,3-cyclobutanediol, p-xylylenediol, or combinations of one or more of these glycols.

The diol residues may include from about 25 mole percent to about 100 mole percent, based on the total diol residues, of residues of a poly(ethylene glycol) having a structure H—(OCH₂—CH₂)ₙ—OH, wherein n is an integer in the range of 2 to about 500. Non-limiting examples of lower molecular weight polyethylene glycols (e.g., wherein n is from 2 to 6) are diethylene glycol, triethylene glycol, and tetraethylene glycol. Of these lower molecular weight glycols, diethylene and triethylene glycol are most preferred. Higher molecular weight polyethylene glycols (abbreviated herein as “PEG”), wherein n is from 7 to about 500, include the commercially available products known under the designation CARBOWAX®, a product of Dow Chemical Company (formerly Union Carbide). Typically, PEGs are used in combination with other diols such as, for example, diethylene glycol or ethylene glycol. Based on the values of n, which range from greater than 6 to 500, the molecular weight may range from greater than 300 to about 22,000 g/mol. The molecular weight and the mole percent are inversely proportional to each other; specifically, as the molecular weight is increased, the mole percent will be decreased in order to achieve a designated degree of hydrophilicity. For example, it is illustrative of this concept to consider that a PEG having a molecular weight of 1,000 g/mol may constitute up to 10 mole percent of the total diol, while a PEG having a molecular weight of 10,000 g/mol would typically be incorporated at a level of less than 1 mole percent of the total diol.

Certain dimer, trimer, and tetramer diols may be formed in situ due to side reactions that may be controlled by varying the process conditions. For example, varying amounts of diethylene, triethylene, and tetraethylene glycols may be derived from ethylene glycol using an acid-catalyzed dehydration reaction which occurs readily when the polycondensation reaction is carried out under acidic conditions. The presence of buffer solutions, well known to those skilled in the art, may be added to the reaction mixture to retard these side reactions. Additional compositional latitude is possible, however, if the buffer is omitted and the dimerization, trimerization, and tetramerization reactions are allowed to proceed.

The sulfopolyesters of the present invention may include from 0 to less than 25, 20, 15, or 10 mole percent, based on the total repeating units, of residues of a branching monomer having 3 or more functional groups wherein the functional groups are hydroxyl, carboxyl, or a combination thereof. Non-lim iting examples of branching monomers are 1,1,1-trimethylol propane, 1,1,1-trimethylolethane, glycerin, pentaerythritol, erythritol, threitol, dipentaerythritol, sorbitol, trimellitic anhydride, pyromellitic dianhydride, dimethylol propionic acid, or combinations thereof. The presence of a branching monomer may result in a number of possible benefits to the sulfopolyesters, including but not limited to, the ability to tailor rheological, solubility, and tensile properties. For example, at a constant molecular weight, a branched sulfopolyester, compared to a linear analog, will also have a greater concentration of end groups that may facilitate post-polymerization crosslinking reactions. At high concentrations of branching agent, however, the sulfopolyester may be prone to gelation.

The sulfopolyester used for the multicomponent fiber can have a glass transition temperature, abbreviated herein as “Tg,” of at least 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., or 65° C. as measured on the dry polymer using standard techniques well known to persons skilled in the art, such as differential scanning calorimetry (“DSC”). The Tg measurements of the sulfopolyesters are conducted using a “dry polymer,” that is, a polymer sample in which adventitious or absorbed water is driven off by heating the polymer to a temperature of about 200° C. and allowing the sample to return to room temperature. Typically, the sulfopolyester is dried in the DSC apparatus by conducting a first thermal scan in which the sample is heated to a temperature above the water vaporization temperature, holding the sample at that temperature until the vaporization of the water absorbed in the polymer is complete (as indicated by a large, broad endotherm), cooling the sample to room temperature, and then conducting a second thermal scan to obtain the Tg measurement.

In one embodiment, our invention provides a sulfopolyester having a glass transition temperature (Tg) of at least 25° C., wherein the sulfopolyester comprises:

(a) at least 50, 60, 75, or 85 mole percent and no more than 96, 95, 90, or 85 mole percent of one or more residues of isophthalic acid and/or terephthalic acid, based on the total acid residues;

(b) about 4 to about 30 mole percent, based on the total acid residues, of a residue of sodiosulfoisophthalic acid;

(c) one or more diol residues wherein at least 25, 50, 70, or 75 mole percent, based on the total diol residues, is a poly(ethylene glycol) having a structure H—(OCH₂—CH₂)ₙ—OH wherein n is an integer in the range of 2 to about 500;

(d) 0 to about 20 mole percent, based on the total repeating units, of residues of a branching monomer having 3 or more functional groups wherein the functional groups are hydroxyl, carboxyl, or a combination thereof.

The sulfopolyesters of the instant invention are readily prepared from the appropriate dicarboxylic acids, esters, anhydrides, salts, sulfomonomer, and the appropriate diol or diol mixtures using typical polycondensation reaction conditions. They may be made by continuous, semi-continuous, and batch modes of operation and may utilize a variety of reactor types. Examples of suitable reactor types include, but are not limited to, stirred tank, continuous stirred tank, slurry, tubular, wiped-film, falling film, or extrusion reactors. The term “continuous” as used herein means a process wherein reactants are introduced and products withdrawn simultaneously in an uninterrupted manner. By “continuous” it is meant that the process is substantially or completely continuous in operation and is to be contrasted with a “batch” process. “Continuous” is not meant in any way to prohibit normal interruptions in the continuity of the process due to, for example, start-up, reactor maintenance, or scheduled shut down periods. The term “batch” process as used herein means a process wherein all the reactants are added to the reactor and then processed according to a predetermined course of reaction during which no material is fed or removed from the reactor. The term “semicontinuous” means a process where some of the reactants are charged at the beginning of the process and the remaining reactants are fed continuously as the reaction progresses. Alternatively, a semicontinuous process may also include a process similar to a batch process in which all the reactants are added at the beginning of the process except that one or more of the products are removed continuously as the reaction progresses. The process is operated advantageously as a continuous process for economic reasons and to produce superior coloration of the polymer as the sulfopolyester may deteriorate in appearance if allowed to reside in a reactor at an elevated temperature for too long a duration.

The sulfopolyesters can be prepared by procedures known to persons skilled in the art. The sulfomonomer is most often added directly to the reaction mixture from which the polymer is made, although other processes are known and may also be employed, for example, as described in U.S. Pat. No. 3,018,272, U.S. Pat. No. 3,075,952, and U.S. Pat. No. 3,033,822. The reaction of the sulfomonomer, diol component, and the dicarboxylic acid component may be carried out using conventional polyester polymerization conditions. For example, when preparing the sulfopolyesters by means of an ester interchange reaction, i.e., from the ester form of the dicarboxylic acid components, the reaction process may comprise two steps. In the first step, the diol component and the dicarboxylic acid component, such as, for example, dimethyl isophthalate, are reacted at elevated temperatures of about 150° C. to about 250° C. for about 0.5 to 8 hours at pressures ranging from about 0.0 kPa gauge to about 414 kPa gauge (60 pounds per square inch, “psig”). Preferably, the temperature for the ester interchange reaction ranges from about 180° C. to about 230° C. for about 1 to 4 hours while the preferred pressure ranges from about 103 kPa gauge (15 psig) to about 276 kPa gauge (40 psig). Thereafter, the reaction product is heated under higher temperatures and under reduced pressure to form a sulfopolyester with the elimination of a diol, which is readily volatilized under these conditions and removed from the system. This second step, or polycondensation step, is continued under higher vacuum conditions and a temperature which generally ranges from about 230° C. to about 350° C., preferably about 250° C. to about 310° C., and most preferably about 260° C. to about 290° C. for about 0.1 to about 6 hours, or preferably, for about 0.2 to about 2 hours, until a polymer having the desired degree of polymerization, as determined by inherent viscosity, is obtained. The polycondensation step may be conducted under reduced pressure which ranges from about 53 kPa (400 torr) to about 0.013 kPa (0.1 torr). Stirring or appropriate conditions are used in both stages to ensure adequate heat transfer and surface renewal of the reaction mixture. The reactions of both stages are facilitated by appropriate catalysts such as, for example, alkoxy titanium compounds, alkali metal hydroxides and alcoholates, salts of organic carboxylic acids, alkyl tin compounds, metal oxides, and the like. A three-stage manufacturing procedure, similar to that described in U.S. Pat. No. 5,290,631 may also be used, particularly when a mixed monomer feed of acids and esters is employed.

To ensure that the reaction of the diol component and dicarboxylic acid component by an ester interchange reaction mechanism is driven to completion, it is preferred to employ about 1.05 to about 2.5 moles of diol component to one mole of dicarboxylic acid component. Persons of skill in the art will understand, however, that the ratio of diol component to dicarboxylic acid component is generally determined by the design of the reactor in which the reaction process occurs.

In the preparation of sulfopolyester by direct esterification, i.e., from the acid form of the dicarboxylic acid component, sulfopolyesters are produced by reacting the dicarboxylic acid or a mixture of dicarboxylic acids with the diol component or a mixture of diol components. The reaction is conducted at a pressure of from about 7 kPa gauge (1 psig) to about 1,379 kPa gauge (200 psig), preferably less than 689 kPa (100 psig) to produce a low molecular weight, linear or branched sulfopolyester product having an average degree of polymerization of from about 1.4 to about 10. The temperatures employed during the direct esterification reaction typically range from about 180° C. to about 280° C., more preferably ranging from about 220° C. to about 270° C. This low molecular weight polymer may then be polymerized by a polycondensation reaction.

As noted hereinabove, the sulfopolyesters are advantageous for the preparation of bicomponent and multicomponent fibers having a shaped cross section. We have discovered that sulfopolyesters or blends of sulfopolyesters having a glass transition temperature (Tg) of at least 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., or 65° C. are particularly useful for multicomponent fibers for preventing blocking and fusing of the fiber during spinning and take up. For example, to obtain a sulfopolyester with a Tg of at least 35° C., blends of one or more sulfopolyesters may be used in varying proportions to obtain a sulfopolyester blend having the desired Tg. The Tg of a sulfopolyester blend may be calculated by using a weighted average of the Tgs of the sulfopolyester components. For example, sulfopolyesters having a Tg of 48° C. may be blended in a 25:75 weight:weight ratio with another sulfopolyester having Tg of 65° C. to give a sulfopolyester blend having a Tg of approximately 61° C.

In another embodiment of the invention, the water dispersible sulfopolyester component of the multicomponent fiber presents properties which allow at least one of the following:

(a) the multicomponent fibers to be spun to a desired low denier,

(b) the sulfopolyester in these multicomponent fibers to be resistant to removal during hydroentangling of a web formed from the multicomponent fibers but is efficiently removed at elevated temperatures after hydroentanglement, and

(c) the multicomponent fibers to be heat settable so as to yield a stable, strong fabric. Surprising and unexpected results were achieved in furtherance of these objectives using a sulfopolyester having a certain melt viscosity and level of sulfomonomer residues.

As previously discussed, the sulfopolyester or sulfopolyester blend utilized in the multicomponent fibers or binders can have a melt viscosity of generally less than about 12,000, 10,000, 6,000, or 4,000 poise as measured at 240° C. and at a 1 rad/sec shear rate. In another aspect, the sulfopolyester or sulfopolyester blend exhibits a melt viscosity of between about 1,000 to 12,000 poise, more preferably between 2,000 to 6,000 poise, and most preferably between 2,500 to 4,000 poise measured at 240° C. and at a 1 rad/sec shear rate. Prior to determining the viscosity, the samples are dried at 60° C. in a vacuum oven for 2 days. The melt viscosity is measured on a rheometer using 25 mm diameter parallel-plate geometry at a 1 mm gap setting. A dynamic frequency sweep is run at a strain rate range of 1 to 400 rad/sec and 10 percent strain amplitude. The viscosity is then measured at 240° C. and at a strain rate of 1 rad/sec.

The level of sulfomonomer residues in the sulfopolyester polymers is at least 4 or 5 mole percent and less than about 25, 20, 12, or 10 mole percent, reported as a percentage of the total diacid or diol residues in the sulfopolyester. Sulfomonomers for use with the invention preferably have 2 functional groups and one or more sulfonate groups attached to an aromatic or cycloaliphatic ring wherein the functional groups are hydroxyl, carboxyl, or a combination thereof. A sodiosulfoisophthalic acid monomer is particularly preferred.

In addition to the sulfomonomer described previously, the sulfopolyester preferably comprises residues of one or more dicarboxylic acids, one or more diol residues wherein at least 25 mole percent, based on the total diol residues, is a poly(ethylene glycol) having a structure H—(OCH₂—CH₂)ₙ—OH wherein n is an integer in the range of 2 to about 500, and 0 to about 20 mole percent, based on the total repeating units, of residues of a branching monomer having 3 or more functional groups wherein the functional groups are hydroxyl, carboxyl, or a combination thereof.

In a particularly preferred embodiment, the sulfopolyester comprises from about 60 to 99, 80 to 96, or 88 to 94 mole percent of dicarboxylic acid residues, from about 1 to 40, 4 to 20, or 6 to 12 mole percent of sulfomonomer residues, and 100 mole percent of diol residues (there being a total mole percent of 200 percent, i.e., 100 mole percent diacid and 100 mole percent diol). More specifically, the dicarboxylic portion of the sulfopolyester comprises between about 50 to 95, 60 to 80, or 65 to 75 mole percent of terephthalic acid, about 0.5 to 49, 1 to 30, or 15 to 25 mole percent of isophthalic acid, and about 1 to 40, 4 to 20, or 6 to 12 mole percent of 5-sodiosulfoisophthalic acid (5-SSIPA). The diol portion comprises from about 0 to 50 mole percent of diethylene glycol and from about 50 to 100 mole percent of ethylene glycol. An exemplary formulation according to this embodiment of the invention is set forth subsequently.

| | Approximate Mole percent (based on |
|---|---|
| | total moles of diol or diacid residues) |
| Terephthalic acid | 71 |
| Isophthalic acid | 20 |
| 5-SSIPA | 9 |
| Diethylene glycol | 35 |
| Ethylene glycol | 65 |

The water dispersible component of the multicomponent fibers may consist essentially of or, consist of, the sulfopolyesters described hereinabove. In another embodiment, however, the sulfopolyesters of this invention may be blended with one or more supplemental polymers to modify the properties of the resulting multicomponent fiber. The supplemental polymer may or may not be water-dispersible depending on the application and may be miscible or immiscible with the sulfopolyester. If the supplemental polymer is water non-dispersible, it is preferred that the blend with the sulfopolyester is immiscible.

The term “miscible,” as used herein, is intended to mean that the blend has a single, homogeneous amorphous phase as indicated by a single composition-dependent Tg. For example, a first polymer that is miscible with second polymer may be used to “plasticize” the second polymer as illustrated, for example, in U.S. Pat. No. 6,211,309. By contrast, the term “immiscible,” as used herein, denotes a blend that shows at least two randomly mixed phases and exhibits more than one Tg. Some polymers may be immiscible and yet compatible with the sulfopolyester. A further general description of miscible and immiscible polymer blends and the various analytical techniques for their characterization may be found in Polymer Blends Volumes 1 and 2, Edited by D. R. Paul and C. B. Bucknall, 2000, John Wiley & Sons, Inc, the disclosure of which is incorporated herein by reference.

Non-limiting examples of water-dispersible polymers that may be blended with the sulfopolyester are polymethacrylic acid, polyvinyl pyrrolidone, polyethylene-acrylic acid copolymers, polyvinyl methyl ether, polyvinyl alcohol, polyethylene oxide, hydroxy propyl cellulose, hydroxypropyl methyl cellulose, methyl cellulose, ethyl hydroxyethyl cellulose, isopropyl cellulose, methyl ether starch, polyacrylam ides, poly(N-vinyl caprolactam), polyethyl oxazoline, poly(2-isopropyl-2-oxazoline), polyvinyl methyl oxazolidone, water-dispersible sulfopolyesters, polyvinyl methyl oxazolidimone, poly(2,4-dimethyl-6-triazinylethylene), and ethylene oxide-propylene oxide copolymers. Examples of polymers which are water non-dispersible that may be blended with the sulfopolyester include, but are not limited to, polyolefins, such as homo- and co-polymers of polyethylene and polypropylene; poly(ethylene terephthalate); poly(butylene terephthalate); and polyamides, such as nylon-6; polylactides; caprolactone; Eastar Bio® (poly(tetramethylene adipate-co-terephthalate), a product of Eastman Chemical Company); polycarbonate; polyurethane; and polyvinyl chloride.

According to our invention, blends of more than one sulfopolyester may be used to tailor the end-use properties of the resulting multicomponent fiber or nonwoven article. The blends of one or more sulfopolyesters will have Tgs of at least 25° C. for the binder compositions and at least 35° C. for the multicomponent fibers.

The sulfopolyester and supplemental polymer may be blended in batch, semicontinuous, or continuous processes. Small scale batches may be readily prepared in any high-intensity mixing devices well known to those skilled in the art, such as Banbury mixers, prior to melt-spinning fibers. The components may also be blended in solution in an appropriate solvent. The melt blending method includes blending the sulfopolyester and supplemental polymer at a temperature sufficient to melt the polymers. The blend may be cooled and pelletized for further use or the melt blend can be melt spun directly from this molten blend into fiber form. The term “melt” as used herein includes, but is not limited to, merely softening the polyester. For melt mixing methods generally known in the polymers art, see Mixing and Compounding of Polymers (I. Manas-Zloczower & Z. Tadmor editors, Carl Hanser Verlag Publisher, 1994, New York, N. Y.).

As previously discussed, the segments or domains of the multicomponent fibers may comprise one or more water non-dispersible synthetic polymers. Examples of water non-dispersible synthetic polymers which may be used in segments of the multicomponent fiber include, but are not limited to, polyolefins, polyesters, copolyesters, polyamides, polylactides, polycaprolactone, polycarbonate, polyurethane, acrylics, cellulose ester, and/or polyvinyl chloride. For example, the water non-dispersible synthetic polymer may be polyester such as polyethylene terephthalate, polyethylene terephthalate homopolymer, polyethylene terephthalate copolymer, polybutylene terephthalate, polycyclohexylene cyclohexanedicarboxylate, polypropylene terephthalate, polycyclohexylene terephthalate, polytrimethylene terephthalate, and the like.

In another embodiment of the invention, the water non-dispersible polymer is derived from recycled materials. Particularly, the water non-dispersible polymer can be recycled polyester.

In another example, the water non-dispersible synthetic polymer can be biodistintegratable as determined by DIN Standard 54900 and/or biodegradable as determined by ASTM Standard Method, D6340-98. Examples of biodegradable polyesters and polyester blends are disclosed in U.S. Pat. No. 5,599,858; U.S. Pat. No. 5,580,911; U.S. Pat. No. 5,446,079; and U.S. Pat. No. 5,559,171. The term “biodegradable,” as used herein in reference to the water non-dispersible synthetic polymers, is understood to mean that the polymers are degraded under environmental influences such as, for example, in a composting environment, in an appropriate and demonstrable time span as defined, for example, by ASTM Standard Method, D6340-98, entitled “Standard Test Methods for Determining Aerobic Biodegradation of Radiolabeled Plastic Materials in an Aqueous or Compost Environment.” The water non-dispersible synthetic polymers of the present invention also may be “biodisintegratable,” meaning that the polymers are easily fragmented in a composting environment as defined, for example, by DIN Standard 54900. For example, the biodegradable polymer is initially reduced in molecular weight in the environment by the action of heat, water, air, microbes, and other factors. This reduction in molecular weight results in a loss of physical properties (tenacity) and often in fiber breakage. Once the molecular weight of the polymer is sufficiently low, the monomers and oligomers are then assimilated by the microbes. In an aerobic environment, these monomers or oligomers are ultimately oxidized to CO₂, H₂O, and new cell biomass. In an anaerobic environment, the monomers or oligomers are ultimately converted to CO₂, H₂, acetate, methane, and cell biomass.

Additionally, the water non-dispersible synthetic polymers may comprise aliphatic-aromatic polyesters, abbreviated herein as “AAPE.” The term “aliphatic-aromatic polyester,” as used herein, means a polyester comprising a mixture of residues from aliphatic dicarboxylic acids, cycloaliphatic dicarboxylic acids, aliphatic diols, cycloaliphatic diols, aromatic diols, and aromatic dicarboxylic acids. The term “non-aromatic,” as used herein with respect to the dicarboxylic acid and diol monomers of the present invention, means that carboxyl or hydroxyl groups of the monomer are not connected through an aromatic nucleus. For example, adipic acid contains no aromatic nucleus in its backbone (i.e., the chain of carbon atoms connecting the carboxylic acid groups), thus adipic acid is “non-aromatic.” By contrast, the term “aromatic” means the dicarboxylic acid or diol contains an aromatic nucleus in its backbone such as, for example, terephthalic acid or 2,6-naphthalene dicarboxylic acid. “Non-aromatic,” therefore, is intended to include both aliphatic and cycloaliphatic structures such as, for example, diols and dicarboxylic acids, which contain as a backbone a straight or branched chain or cyclic arrangement of the constituent carbon atoms which may be saturated or paraffinic in nature, unsaturated (i.e., containing non-aromatic carbon-carbon double bonds), or acetylenic (i.e., containing carbon-carbon triple bonds). Thus, non-aromatic is intended to include linear and branched, chain structures (referred to herein as “aliphatic”) and cyclic structures (referred to herein as “alicyclic” or “cycloaliphatic”). The term “non-aromatic,” however, is not intended to exclude any aromatic substituents which may be attached to the backbone of an aliphatic or cycloaliphatic diol or dicarboxylic acid. In the present invention, the difunctional carboxylic acid typically is a aliphatic dicarboxylic acid such as, for example, adipic acid, or an aromatic dicarboxylic acid such as, for example, terephthalic acid. The difunctional hydroxyl compound may be cycloaliphatic diol such as, for example, 1,4-cyclohexanedimethanol, a linear or branched aliphatic diol such as, for example, 1,4-butanediol, or an aromatic diol such as, for example, hydroquinone.

The AAPE may be a linear or branched random copolyester and/or chain extended copolyester comprising diol residues which comprise the residues of one or more substituted or unsubstituted, linear or branched, diols selected from aliphatic diols containing 2 to 8 carbon atoms, polyalkylene ether glycols containing 2 to 8 carbon atoms, and cycloaliphatic diols containing about 4 to about 12 carbon atoms. The substituted diols, typically, will comprise 1 to 4 substituents independently selected from halo, C₆-C₁₀ aryl, and C₁-C₄ alkoxy. Examples of diols which may be used include, but are not limited to, ethylene glycol, diethylene glycol, propylene glycol, 1,3-propanediol, 2,2-dimethyl-1,3-propanediol, 1,3-butanediol, 1,4-butanediol, 1,5-pentanediol, 1,6-hexanediol, polyethylene glycol, diethylene glycol, 2,2,4-trimethyl-1,6-hexanediol, thiodiethanol, 1,3-cyclohexanedimethanol, 1,4-cyclo-hexanedimethanol, 2,2,4,4-tetramethyl-1,3-cyclobutanediol, triethylene glycol, and tetraethylene glycol. The AAPE also comprises diacid residues which contain about 35 to about 99 mole percent, based on the total moles of diacid residues, of the residues of one or more substituted or unsubstituted, linear or branched, non-aromatic dicarboxylic acids selected from aliphatic dicarboxylic acids containing 2 to 12 carbon atoms and cycloaliphatic acids containing about 5 to 10 carbon atoms. The substituted non-aromatic dicarboxylic acids will typically contain 1 to about 4 substituents selected from halo, C₆-C₁₀ aryl, and C₁-C₄ alkoxy. Non-limiting examples of non-aromatic diacids include malonic, succinic, glutaric, adipic, pimelic, azelaic, sebacic, fumaric, 2,2-dimethyl glutaric, suberic, 1,3-cyclopentanedicarboxylic, 1,4-cyclohexanedicarboxylic, 1,3-cyclohexanedicarboxylic, diglycolic, itaconic, maleic, and 2,5-norbornane-dicarboxylic. In addition to the non-aromatic dicarboxylic acids, the AAPE comprises about 1 to about 65 mole percent, based on the total moles of diacid residues, of the residues of one or more substituted or unsubstituted aromatic dicarboxylic acids containing 6 to about 10 carbon atoms. In the case where substituted aromatic dicarboxylic acids are used, they will typically contain 1 to about 4 substituents selected from halo, C₆-C₁₀ aryl, and C₁-C₄ alkoxy. Non-limiting examples of aromatic dicarboxylic acids which may be used in the AAPE of our invention are terephthalic acid, isophthalic acid, salts of 5-sulfoisophthalic acid, and 2,6-naphthalenedicarboxylic acid. More preferably, the non-aromatic dicarboxylic acid will comprise adipic acid, the aromatic dicarboxylic acid will comprise terephthalic acid, and the diol will comprise 1,4-butanediol.

Other possible compositions for the AAPE are those prepared from the following diols and dicarboxylic acids (or polyester-forming equivalents thereof such as diesters) in the following mole percentages, based on 100 mole percent of a diacid component and 100 mole percent of a diol component:

(1) glutaric acid (about 30 to about 75 mole percent), terephthalic acid (about 25 to about 70 mole percent), 1,4-butanediol (about 90 to 100 mole percent), and modifying diol (0 about 10 mole percent);

(2) succinic acid (about 30 to about 95 mole percent), terephthalic acid (about 5 to about 70 mole percent), 1,4-butanediol (about 90 to 100 mole percent), and modifying diol (0 to about 10 mole percent); and

(3) adipic acid (about 30 to about 75 mole percent), terephthalic acid (about 25 to about 70 mole percent), 1,4-butanediol (about 90 to 100 mole percent), and modifying diol (0 to about 10 mole percent).

The modifying diol preferably is selected from 1,4-cyclohexanedimethanol, triethylene glycol, polyethylene glycol, and neopentyl glycol. The most preferred AAPEs are linear, branched, or chain extended copolyesters comprising about 50 to about 60 mole percent adipic acid residues, about 40 to about 50 mole percent terephthalic acid residues, and at least 95 mole percent 1,4-butanediol residues. Even more preferably, the adipic acid residues comprise about 55 to about 60 mole percent, the terephthalic acid residues comprise about 40 to about 45 mole percent, and the diol residues comprise about 95 mole percent 1,4-butanediol residues. Such compositions are commercially available under the trademark EASTAR BIO® copolyester from Eastman Chemical Company, Kingsport, Tenn., and under the trademark ECOFLEX® from BASF Corporation.

Additional, specific examples of preferred AAPEs include a poly(tetra-methylene glutarate-co-terephthalate) containing (a) 50 mole percent glutaric acid residues, 50 mole percent terephthalic acid residues, and 100 mole percent 1,4-butanediol residues, (b) 60 mole percent glutaric acid residues, 40 mole percent terephthalic acid residues, and 100 mole percent 1,4-butanediol residues, or (c) 40 mole percent glutaric acid residues, 60 mole percent terephthalic acid residues, and 100 mole percent 1,4-butanediol residues; a poly(tetramethylene succinate-co-terephthalate) containing (a) 85 mole percent succinic acid residues, 15 mole percent terephthalic acid residues, and 100 mole percent 1,4-butanediol residues or (b) 70 mole percent succinic acid residues, 30 mole percent terephthalic acid residues, and 100 mole percent 1,4-butanediol residues; a poly(ethylene succinate-co-terephthalate) containing 70 mole percent succinic acid residues, 30 mole percent terephthalic acid residues, and 100 mole percent ethylene glycol residues; and a poly(tetramethylene adipate-co-terephthalate) containing (a) 85 mole percent adipic acid residues, 15 mole percent terephthalic acid residues, and 100 mole percent 1,4-butanediol residues; or (b) 55 mole percent adipic acid residues, 45 mole percent terephthalic acid residues, and 100 mole percent 1,4-butanediol residues.

The AAPE preferably comprises from about 10 to about 1,000 repeating units and preferably, from about 15 to about 600 repeating units. The AAPE may have an inherent viscosity of about 0.4 to about 2.0 dL/g, or more preferably about 0.7 to about 1.6 dL/g, as measured at a temperature of 25° C. using a concentration of 0.5 g copolyester in 100 ml of a 60/40 by weight solution of phenol/tetrachloroethane.

The AAPE, optionally, may contain the residues of a branching agent. The mole percent ranges for the branching agent are from about 0 to about 2 mole percent, preferably about 0.1 to about 1 mole percent, and most preferably about 0.1 to about 0.5 mole percent based on the total moles of diacid or diol residues (depending on whether the branching agent contains carboxyl or hydroxyl groups). The branching agent preferably has a weight average molecular weight of about 50 to about 5,000, more preferably about 92 to about 3,000, and a functionality of about 3 to about 6. The branching agent, for example, may be the esterified residue of a polyol having 3 to 6 hydroxyl groups, a polycarboxylic acid having 3 or 4 carboxyl groups (or ester-forming equivalent groups), or a hydroxy acid having a total of 3 to 6 hydroxyl and carboxyl groups. In addition, the AAPE may be branched by the addition of a peroxide during reactive extrusion.

The water non-dispersible components of the multicomponent fibers of this invention also may contain other conventional additives and ingredients which do not deleteriously affect their end use. For example, additives include, but are not limited to, starches, fillers, light and heat stabilizers, antistatic agents, extrusion aids, dyes, anticounterfeiting markers, slip agents, tougheners, adhesion promoters, oxidative stabilizers, UV absorbers, colorants, pigments, opacifiers (delustrants), optical brighteners, fillers, nucleating agents, plasticizers, viscosity modifiers, surface modifiers, antimicrobials, antifoams, lubricants, thermostabilizers, emulsifiers, disinfectants, cold flow inhibitors, branching agents, oils, waxes, and catalysts.

In one embodiment of the invention, the multicomponent fibers will contain less than 10 weight percent of anti-blocking additives, based on the total weight of the multicomponent fiber or nonwoven article. The multicomponent fiber may contain less than 10, 9, 5, 3, or 1 weight percent of a pigment or filler based on the total weight of the multicomponent fiber. Colorants, sometimes referred to as toners, may be added to impart a desired neutral hue and/or brightness to the water non-dispersible polymer. When colored fibers are desired, pigments or colorants may be included when producing the water non-dispersible polymer or they may be melt blended with the preformed water non-dispersible polymer. A preferred method of including colorants is to use a colorant having thermally stable organic colored compounds having reactive groups such that the colorant is copolymerized and incorporated into the water non-dispersible polymer to improve its hue. For example, colorants such as dyes possessing reactive hydroxyl and/or carboxyl groups, including, but not limited to, blue and red substituted anthraquinones, may be copolymerized into the polymer chain.

The multicomponent fiber of this invention can be produced by any method known in the art. In one embodiment of the invention, a process is provided to produce the multicomponent fiber; wherein the process comprises spinning a multicomponent fiber having a shaped cross section; wherein the multicomponent fiber comprises at least one water dispersible polymer and a plurality of domains comprising one or more water non-dispersible polymers; wherein the domains are substantially isolated from each other by the water dispersible polymer intervening between the domains; and wherein the water dispersible polymer is present at the perimeter of the outside cross-section of the multicomponent fiber in a proportion of not greater than 55% water dispersible polymer.

Inventive fibers according to the instant invention may be produced via different techniques. The inventive fibers may for example, be produced via melt spinning. The inventive fibers according to instant invention may be continuous filaments, or in the alternative, the inventive fibers may be staple fibers. Continuous filaments may further be optionally crimped, and then cut to produce staple fibers.

In melt spinning, the water dispersible polymer and the water non-dispersible polymer plus any additional polymers are melt extruded and forced through the fine orifices in a metallic plate called a spinneret into air or other gas to produce the multicomponent fiber, where it is cooled and solidified. This process is called extrusion or spinning. Spinning also can encompass the process of entangling filaments together to produce a yarn. The solidified filaments may be drawn-off via rotating rolls, or godets, and wound onto bobbins.

The multicomponent fibers of this invention can be used to produce yarns. Yarns are defined as continuous strands of fibers that are suitable for weaving, knitting, fusing, or otherwise intertwining to produce a textile article, such as a fabric. In one embodiment of the invention, the multicomponent fiber is a filament yarn. Filament yarns are first drawn into continuous lengths of fiber and may be twisted during post processing. In another embodiment of this invention, the multicomponent fiber is cut into staple lengths and then twisted into a continuous strand called a spun yarn.

In another embodiment of this invention, the multicomponent fiber can be combined with at least one other fiber to produce a yarn. The yarn may be a spun yarn or filament yarn. The other fiber can include, but is not limited to, cotton, linen, silk, sisal/grass, leather, acetate, acrylic, modacrylic, polylactide, saran, cellulosic fiber pulp, inorganic fibers (e.g., glass, carbon, boron, ceramic, and combinations thereof), polyester fibers, nylon fibers, polyolefin fibers, rayon fibers, lyocell fibers, cellulose ester fibers, post-consumer recycled fibers, elastomeric fibers and combinations thereof.

Optionally, the multicomponent fibers may be post processed by various techniques, such as, drawing or texturing. Drawn fibers may be textured and wound-up to form a bulky continuous filament. A one-step technique is known in the art as spin-draw-texturing. Other embodiments include flat filament (non-textured) yarns, or cut staple fiber, either crimped or uncrimped.

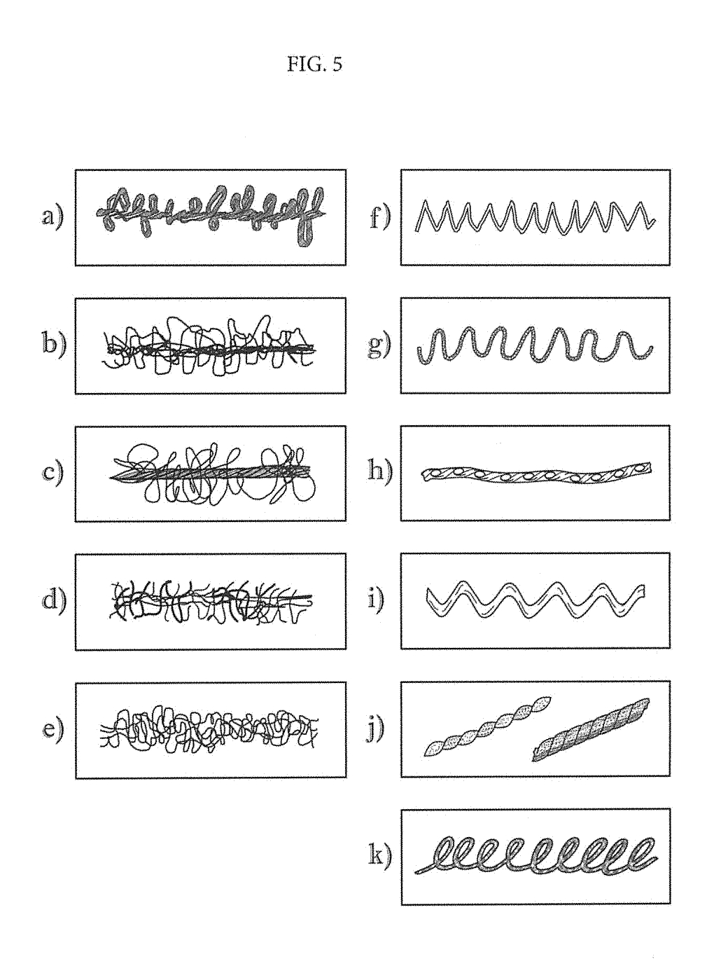

Texturing, as used herein, refers to treating the flat filaments (or fibers) so that they are distorted to have loops, coils, curl, crimps or other deformation (i.e., ‘texture’) along the length of the filaments. Texturing the filaments or fibers increases bulkiness, porosity, elasticity and/or softness of the fiber. Different amounts (or degrees) of texturing can provide filaments and fibers with different properties. Texturing and texturizing may be used interchangeably herein. In FIG. 5, various types of textured fibers or yarns are shown.

The filaments and fibers are then used to make a yarn. The filaments or fibers may be combined with other filaments or fibers to make yarn, and more than one yarn may be combined together to make a new yarn by processes such as texturing, wrapping and the like, as known to one of skill in the art.

The drawn filaments or fibers may be textured to add crimp or deformation as well as bulk to the fiber depending on the desired properties using processes such as friction disk draw texturing (also referred to as false twist texturing), air jet texturing, knife edge texturing, stuffer box texturing and draw winding.

Many commercial texturing operations are designed for high production throughput and therefore use long heaters that can reach high temperatures. This enables high draw ratios of partially oriented yarn while achieving high yarn velocities. The use of short electric heaters in friction disk draw texturing processes are not as common as longer heaters because with shorter heaters, the throughput of the yarn is reduced or limited.

For some fibers, such as multicomponent fibers having a water dispersible component, the standard operating conditions and higher temperatures in the heating zone will not allow the texturing process to be successfully operated. If the temperature is too high, any twist that is created in the fiber or filaments may cause the entire yarn filament bundle to fuse while traveling through the heater. The conventional process temperatures significantly reduce the torsional elasticity, which causes the yarn to break due to further twisting forces and/or longitudinal stain due to draw forces.

Operating heaters at temperatures below 140° C. and providing input/feed yarn that is highly oriented (HOY) is unusual, but the inventors have found that by providing highly oriented yarn and reducing the heating temperature, it is possible to provide textured fibers that are suitable for further use, such as for subsequent yarn construction steps, non-woven, woven and/or knitting applications.

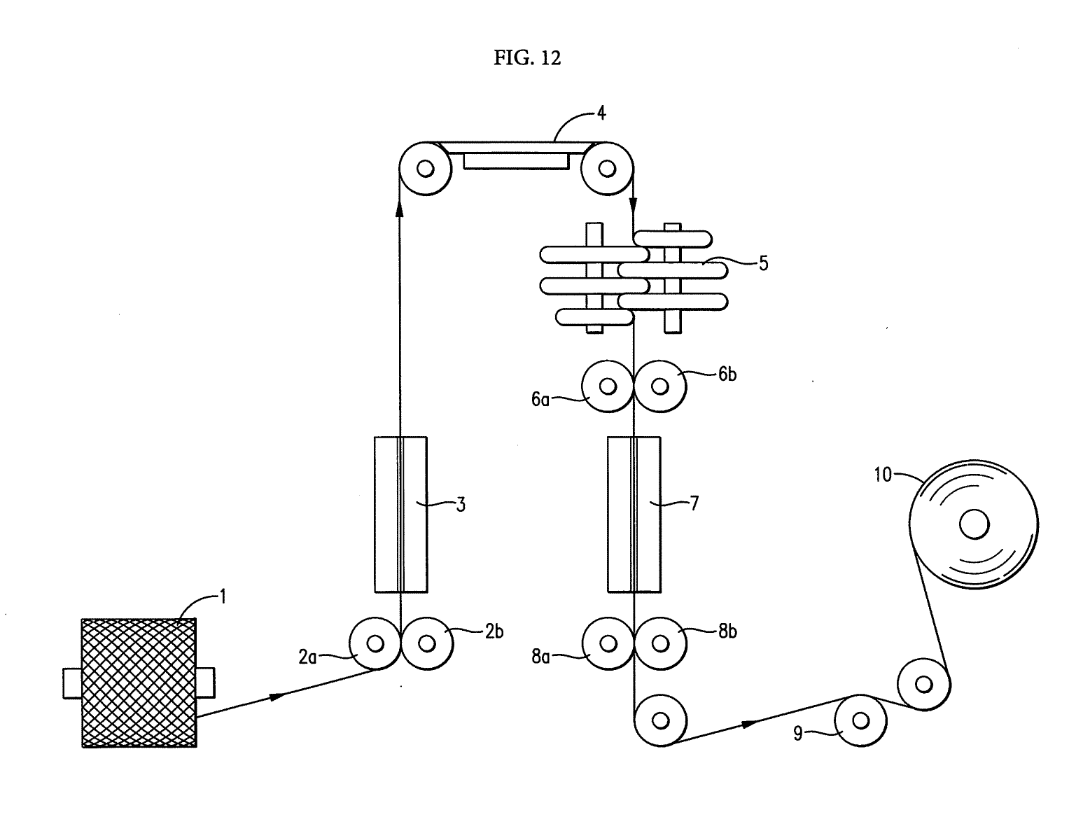

In an embodiment, the inventive fibers or filaments are texturized using a friction disk texturing process. An example schematic of a friction disk texturing process is shown in FIG. 12. In an embodiment, the friction disk texturing process comprises the steps of providing a fiber or filament, such as the multicomponent fiber of the invention, to a first zone wherein the fiber is heated, drawn and twisted; and optionally, providing the fiber to a second zone wherein the fiber is heated; and finally collecting or winding the fiber for further processing or use, such as in fabric. In the first zone, the fiber is heated, and the heating temperature is less than the temperature used for a fiber without the water dispersible component, such as at least 10% less, or at least 15%, at least 20%, at least 25%, at least 30%, at least 35%, at least 40%, at least 45%, at least 50%, at least 55%, or at least 60% less than the conventional heating temperature for a fiber without the water dispersible component having the same water non-dispersible polymer, same number of total filaments in the fiber, and the same total denier for a given type of equipment. For example, for a conventional fiber, such as, a polyester fiber, the heating element in the first zone may be operated at a temperature of about 180 to 200° C. or higher. For the texturing process of the invention, the heating element 3 in the friction disk texturing process is operated at a lower temperature, such as a temperature of about 85 to 140° C., depending on the type of fiber, and in embodiments, the amount of water dispersible material, and desired properties.

In an exemplary friction disk texturing process, fiber or filaments may be provided to the first zone via an input shaft or rollers (2a, 2b) from a bobbin 1 or other device for holding the filaments known in the art. The first zone is located between rollers 2 and 6 and comprises at least one heater, optionally at least one cooling plate, and at least one friction disk. The input shaft (or feed rollers 2a, 2b) generally provides a uniform tension as the fiber or filament is fed to the texturing process.

The fiber may be any type of fiber, such as partially oriented yarn (POY) or fiber, highly oriented yarn or fiber (HOY) or fully drawn yarn or fiber (FDY). A partially oriented yarn is a yarn that has been formed using no significant drawing or heat-setting. This produces a yarn that has very little orientation. A highly oriented yarn is a yarn that has been formed using some drawing and heat-setting. This produces a yarn that has some amount of orientation. A fully drawn yarn is a yarn that has been formed using significant drawing and heat-setting. This produces a yarn that has a significant amount of orientation.

The fiber may be provided to the first zone by any device known in the art to provide tension on the fiber as it is fed to the texturing process. The first or primary heater 3 or heating element in the first zone may be a contact or non-contact heating element, such as an electric heater (such as a short electric heater), a heating tube, and the like. The heating element in some embodiments may be from 1 to 3 meters long, although other heaters are known in the art.

In the first zone, the fiber or filaments are heated just enough to allow for the polymer chains to move, which allows the fibers to remain ‘crimped’ or textured, but not too hot to ‘melt’ the polymers. If the temperature is too high, the combination of the temperature and drawing force may cause the multi-component fiber to break, knot and/or fuse or stick together, and the texturing process will be ineffective. If the temperature is too low (i.e., not hot enough to warm or heat the fiber to impart enough thermal energy), then the texturing process will be unsuccessful, and the resulting fiber will not have the desired texture or may break. The heating zone 3 must be hot enough to allow the fiber to be drawn without breaking.

In embodiments, in the first zone, the fiber is heated and twisted. In embodiments, the heating and twisting may happen substantially simultaneously, while in other embodiments, the heating and twisting may be controlled independently and happen step wise. Further, after the fiber is heated and twisted, it may be cooled either by contact or by non-contact means. In embodiments, in the first zone, the fiber is heated, drawn and twisted. In embodiments, the heating, drawing and twisting may happen substantially simultaneously, while in other embodiments, the heating, drawing and twisting may be controlled independently and happen step wise.

Drawing refers to a process for elongating the filaments of the fiber. This may be done by passing the fiber through sets of rollers in series, such as godet pairs, where each subsequent pair of rollers moves faster than the previous set to elongate or “draw” the fibers. The fiber is drawn to the desired strength, toughness and elastic properties. Drawing may be done cold or hot, depending on the fiber type and desired properties. Drawing helps to align or orient the molecules in the fiber. The draw ratio, or amount of draw necessary, will vary depending on the starting fiber and the desired fiber properties such as denier and strength.

The first zone may also comprise a cooling zone or a cooling device 4 to cool the fiber. By providing crimp or texture, the fiber will remain crimped even when untwisted or released from the distorted state. The cooling device 4 may comprise cooling plates, a water cooling device, such as, water contact tubes, an air cooling device, or a combination of cooling devices, and the cooling may be done by contact or non-contact methods. The cooling device 4 or zone removes or transfers heat away from the fiber to reduce the temperature of the fiber, and any cooling device or method known in the art may be used.

The first zone comprises at least one twisting unit 5 or other means to impart a twist to the filaments within the fiber. The twisting unit 5 may comprise friction disks or spindles or other devices that contact the fiber to impart a twist in the yarn. The twisting unit 5 imparts a twist which generally travels back to the input shaft or feed rollers 2a, 2b as either an “S” or a “Z” twist (clockwise or counterclockwise) and forward to the center shaft or rollers 6a, 6b in the opposite direction to reverse the twist. In embodiments, the fiber or filaments are twisted while being heated (in the heating zone 3), which texturizes it. Since there is minimal, and in some cases, substantially no net twist in the fiber or filament after the first zone, this is referred to as a false twist.

The heating device 3, cooling device 4 and twisting unit 5 are spatially independent. In embodiments, the heating device 3, cooling device 4 and twisting unit 5 are consecutively located in the process (such as shown in FIG. 12).

After the first zone, the fiber may optionally be provided to a second zone after passing another set of rollers 6a, 6b (or a center shaft). The second zone may be a post-heating zone 7, and it may comprise any of the same types of heating elements as the first heating zone, or the second heating zone 7 may comprise heated godets or other heated rollers. In the second heating zone 7 (or post-heat zone), when present, the heating temperature may be the same as the temperature used in conventional processes, or the temperature may be less than the temperature used for a conventional fiber, such as a fiber without water dispersible component. In the second heating zone 7, the temperature may be at least 5% less, or at least 10%, at least 15%, at least 20%, at least 25%, at least 30%, at least 35%, at least 40%, at least 45%, at least 50%, at least 55%, or at least 60% less than the conventional temperature for a fiber without the water dispersible component having the same water non-dispersible polymer, same number of total filaments in the fiber, and the same total denier for a given type of equipment. For a conventional fiber, such as a polyester fiber, the second zone 7 may be operated at a temperature of about 180° C. or higher to provide non-contact heating to the fiber. For a multicomponent fiber, in some embodiments, the second heating zone 7 is operated at a lower temperature, such as a temperature of from about 60° C. up to 140° C. for contact heating, or from about 80° C. up to 150° C. for non-contact heating, depending on the type of fiber, the amount of water dispersible material, and desired properties of the fiber. In other embodiments, the second heating zone may be operated at the same temperature as for conventional fibers, such as polyester fibers.

In embodiments where no second heating is necessary, the second zone 7 may be set to ‘off’ to avoid additional heat. In embodiments, the second zone 7 helps to control the shrinkage and crimp level of the fiber. Additionally, controlling the speed (or speed difference) between the center shaft 6a, 6b and the overfeed shaft or rollers 8a, 8b (or other device used to take up the fiber) helps to control or adjust shrinkage and crimp levels of the fiber. In embodiments, a second heating zone 7 is present and is providing heat to stabilize the fiber or reduce the shrinkage level of the fiber.

After the optional second heating zone 7 and rollers 8a, 8b, the fiber is then wound up onto a bobbin 10 or other device to collect the texturized yarn for further use or processing. There may optionally be a finish applicator 9 or other rollers or devices not shown, depending on the desired set up. Other devices can include an air interlace jet.

In embodiments, multiple different types of fibers may be textured simultaneously. In another aspect of the invention, two or more fibers may be co-textured or textured concurrently in a process similar to that shown in FIG. 12. The additional fiber(s) may be fed into a separate first zone with appropriate heating temperatures depending on the fiber. Each fiber will have its own heating zone 3, and the temperature and conditions of the heating zone for any additional fiber(s) will depend on the composition of the fiber(s). After each heating zone 3, optional cooling zone 4 and twisting unit 5, the additional fiber(s) may be blended or brought together by any means known in the art. An additional fiber(s) that is not texturized may also be blended or brought together with the texturized fiber.

The additional fiber(s) can have a different composition and/or configuration (e.g., length, minimum transverse dimension, maximum transverse dimension, cross-sectional shape, or combinations thereof) than the multi-component fibers and can be of any type of fiber that is known in the art depending on the desired properties and type of fiber to be produced. In one embodiment of the invention, the additional fiber can be selected from the group consisting cotton, linen, silk, sisal/grass, leather, acetate, acrylic, modacrylic, polylactide, saran, cellulosic fiber pulp, inorganic fibers (e.g., glass, carbon, boron, ceramic, and combinations thereof), polyester fibers, nylon fibers, polyolefin fibers, rayon fibers, lyocell fibers, cellulose ester fibers, post-consumer recycled fibers, elastomeric fibers and combinations thereof. The additional fibers may be present in an amount of at least 1, 2, 5, 10, 15, 20, 25, 30, 40, or 60 weight percent of the total fiber content and/or not more than 99, 98, 95, 90, 85, 80, 70, 60, or 50 weight percent of the total fiber content. In one embodiment, the additional fiber is selected from polyester fibers, nylon fibers, and elastomeric fibers. In embodiments, the additional fibers may or may not be texturized.

In another embodiment, the fibers are texturized using an air jet texturing process. In the air jet texturing process, the fibers or filaments are provided at high speed into an area or chamber where a high pressure stream(s) of fluid, such as compressed air, is blown into the chamber. The air causes the filaments to spread apart and form loops, crimps and/or random entanglements, which are retained after the chamber to form the texture. The fibers or filaments are fed into the chamber at an overfeeding rate (i.e., that is, at a rate faster than they are removed from the air jet section or zone). The amount of texturing can be controlled by process conditions such as the air pressure, type and size of air nozzles, fiber types, and the like. Multiple fibers (or feeds) can be provided to the chamber to provide a finished yarn that has more than one fiber entangled together, such as a core or base yarn and an effect yarn.

In another embodiment, the inventive fibers are texturized using a stuffer box texturing process. In a stuffer box texturing process, fibers or filaments pass through a heated “box” or chamber which provides a random wavy crimped pattern in the fibers or filaments when they are heated. The fibers are fed at an overfeed rate, that is, at a rate faster than they are removed from the box or chamber, which allows them to crimp while in the box. After exiting the box, the crimped or textured fibers are cooled using any cooling method known in the art.

In another embodiment, the inventive fibers are texturized using a knife edge texturing process. In a knife edge texturing process, fibers or filaments are heated and pulled across a sharp edge or “knife” at an acute angle, which provides a curled appearance (similar to a ribbon that has been pulled across the blade of a pair of scissors). After the filaments are pulled across the knife, they are cooled to ‘set’ the texture and the curl or spring is retained.

After texturing, any of the textured fibers or yarn may then be further processed or combined with other yarn using processes such as plying, twisting and covering. The yarn may also be package dyed.

The inventive multicomponent fibers can be used to produce any articles known in the art. Inventive articles according to the instant invention include, but are not limited to, non-woven fabrics, knitted fabrics, woven fabrics, braids, and combinations thereof. Synthetic fabrics comprising the inventive multicomponent fibers can also be produced, such as, for example, synthetic suede.

The inventive woven fabrics according to the instant invention may be fabricated from the inventive multicomponent fibers via different techniques. Such methods include, but are not limited to, weaving, braiding, and knitting processes.

In the weaving process, two sets of yarns, i.e. warp and weft, are interlaced to form the inventive woven fabric. The manner in which the two sets of yarns are interlaced determines the weave. The weaving process may be achieved via different equipment including, but not limited to, a Dobby loom, Jacquard loom, and Power loom. By using various combinations of the five basic weaves, i.e. plain, twill, satin, jacquard, and pile, it is possible to produce an almost unlimited variety of constructions.

In the knitting process, the inventive fabric is formed by interlooping a series of loops or one or more yarns. The two major classes of knitting include, but are not limited to, warp knitting and weft knitting.

Warp knitting is a type of knitting in which the yarns generally run lengthwise in the fabric. The yarns are prepared as warps on beams with one or more yarns for each needle. Weft knitting is, however, a common type of knitting in which one continuous thread runs crosswise in the fabric making all of the loops in one course. Weft knitting types are circular and flat knitting.

Braiding is a method to produce fabric wherein the interlacing is at an angle other than 90 degrees. To braid is to interweave or twine three or more separate strands of one or more materials in a diagonally overlapping pattern. Compared with the process of weaving, which usually involves two separate, perpendicular groups of strands (warp and weft), a braid is usually long and narrow, with each component strand functionally equivalent in zigzagging forward through the overlapping mass of the other strands resulting in an intersection angle other than perpendicular.

The woven, knitted, braided, or combination fabrics can be utilized in any article known in the art. The woven, knitted, or braided articles can be used in any type of apparel, footwear, home decor articles, military applications, and technical applications. Apparel can include sports and outdoor garments, industrial clothing, and everyday use clothing. Examples of sports and outdoor garments include, but are not limited to, base layers, jackets and vests, woven sports and fishing shirts, pants and shorts, socks, accessories, swimwear, and mid-layers, sweaters, and sweatshirts. Examples of industrial clothing includes military exercise clothing, clean room clothing, personal protective equipment, medical drapes and gowns, industrial uniforms, and prescription compression orthopedics. Examples of everyday apparel include, but are not limited to, intimate wear, jackets and vests, suits, dresses, oxford and collared woven shirts, skirts, tops, shirts, leggings, tights, pants, shorts and jeans. Footwear includes, but is not limited to, sandals, boots, hiking boots, trail runners, ski and snow boots, other sports and outdoor footwear, tennis shoes, business shoes, work boots, other everyday and athletic/leisure shoes. Examples of home decor articles include, but are not limited to, accessories, awnings, bath items, bed linens, bedspreads and comforters, blankets and throws, broadloom carpet, carpet backing, curtains, draperies, fiberfill paddings, kitchen linens, lampshades, linings, mattress pads, mattress ticking, oriental folk and designer rugs, outdoor carpeting/upholstery, passementerie (fringe), scatter and accent rugs, slipcovers, tablecloths and linens, upholstery, wallcoverings, wall tapestries, cleaning cloths, and woven floor mats and squares. Technical applications include, but are not limited to, barrier fabrics, geotextiles, and auto fabrics. Examples of barrier fabrics include, but are not limited to, clean room cloths, filtration, flags and banners, packaging, and tapes. Auto fabrics include, but are not limited to, auto upholstery, airbags, and other auto fabrics. Geotextiles include permeable fabrics which, when used in association with son, have the ability to separate, filter, reinforce, protect, or drain.

The non-woven fabrics according to the instant invention may be fabricated via different techniques. Such methods include, but are not limited to, melt blown process, spun-bond process, carded web process, air laid process, thermo-calendering process, adhesive bonding process, hot air bonding process, needle punch process, hydroentangling process, electrospinning process, and combinations thereof.

In the melt blown process, the inventive non-woven fabric is formed by extruding molten water dispersible polymer and water non-dispersible polymer in addition to any other polymers known in the art through a die, then, attenuating and/or optionally breaking the resulting filaments with hot, high-velocity air or stream thereby forming short or long fiber lengths collected on a moving screen where they bond during cooling.

In the alternative, the melt blown process generally includes the following steps: (a) extruding strands from a spinneret; (b) simultaneously quenching and attenuating the polymer stream immediately below the spinneret using streams of high velocity heated air; (c) collecting the drawn strands into a web on a foraminous surface. Melt blown webs can be bonded by a variety of means including, but not limited to, autogeneous bonding, i.e. self bonding without further treatment, thermo-calendering process, adhesive bonding process, hot air bonding process, needle punch process, hydroentangling process, and combinations thereof.

In the spunbond process, the fabrication of non-woven fabric includes the following steps: (a) extruding strands of the water dispersible polymer and water non-dispersible polymer in addition to any other polymers known in the art from a spinneret; (b) quenching the strands with a flow of air which is generally cooled in order to hasten the solidification of the molten strands; (c) attenuating the filaments by advancing them through the quench zone with a draw tension that can be applied by either pneumatically entraining the filaments in an air stream or by wrapping them around mechanical draw rolls of the type commonly used in the textile fibers industry; (d) collecting the drawn strands into a web on a foraminous surface, e.g. moving screen or porous belt; and (e) bonding the web of loose strands into the non-woven fabric. Bonding can be achieved by a variety of means including, but not limited to, thermo-calendering process, adhesive bonding process, hot air bonding process, needle punch process, hydroentangling process, and combinations thereof.

The inventive multicomponent fibers may be used to produce a wide variety of nonwoven articles including filter media (e.g., HEPA filters, ULPA filters, coalescent filters, liquid filters, desalination filters, automotive filters, coffee filters, tea bags, and vacuum dust bags), battery separators, personal hygiene articles, sanitary napkins, tampons, diapers, disposable wipes (e.g., automotive wipes, baby wipes, hand and body wipes, floor cleaning wipes, facial wipes, toddler wipes, dusting and polishing wipes, and nail polish removal wipes), flexible packaging (e.g., envelopes, food packages, multiwall bags, and terminally sterilized medical packages), geotextiles (e.g., weed barriers, irrigation barriers, erosion barriers, and seed support media), building and construction materials (e.g., housing envelopes, moisture barrier film, gypsum board, wall paper, asphalt, papers, roofing underlayment, and decorative materials), surgical and medical materials (e.g., surgical drapes and gowns, bone support media, and tissue support media), security papers (e.g., currency paper, gaming and lottery paper, bank notes, and checks), cardboard, recycled cardboard, synthetic leather and suede, automotive headliners, personal protective garments, acoustical media, concrete reinforcement, flexible perform for compression molded composites, electrical materials (e.g., transformer boards, cable wrap and fillers, slot insulations, capacitor papers, and lampshade), catalytic support membranes, thermal insulation, labels, food packaging materials (e.g., aseptic, liquid packaging board, tobacco, release, pouch and packet, grease resistant, ovenable board, cup stock, food wrap, and coated one side), and printing and publishing papers (e.g., water and tear resistant printing paper, trade book, banners, map and chart, opaque, and carbonless). In one embodiment, the nonwoven article is selected from the group consisting of a battery separator, a high efficiency filter, and a high strength paper.

Additional nonwoven articles and the processes to produce such nonwoven articles are disclosed in U.S. Pat. No. 6,989,193, US Patent Application Publication No. 2005/0282008, US Patent Application Publication No. 2006/0194047, U.S. Pat. No. 7,687,143, US Patent Application No. 2008/0311815, and US Patent Application Publication No. 2008/0160859, the disclosures of which are incorporated herein by reference.

A binder dispersion may be applied to the nonwoven article by any method known in the art. In one embodiment, the binder dispersion is applied as an aqueous dispersion to the nonwoven article by spraying or rolling the binder dispersion onto the nonwoven article. Subsequent to applying the binder dispersion, the nonwoven article and the binder dispersion can be subjected to a drying step in order to allow the binder to set.

The binder dispersion may comprise a synthetic resin binder and/or a phenolic resin binder. The synthetic resin binder is selected from the group consisting of acrylic copolymers, styrenic copolymers, styrene-butadiene copolymers, vinyl copolymers, polyurethanes, sulfopolyesters, and combinations thereof. In one embodiment, the binder can comprise a blend of different sulfopolyesters having different sulfomonomer contents. For example, at least one of the sulfopolyesters comprises at least 15 mole percent of sulfomonomer and at least 45 mole percent of CHDM (consider spelling out the first time) and/or at least one of the sulfopolyesters comprises less than 10 mole percent of sulfomonomer and at least 70 mole percent of CHDM. The amount of sulfomonomer present in a sulfopolyester greatly affects its water-permeability. In another embodiment, the binder can be comprised of a sulfopolyester blend comprising at least one hydrophilic sulfopolyester and at least one hydrophobic sulfopolyester. An example of a hydrophilic sulfopolyester that can be useful as a binder is Eastek 1100® by EASTMAN. Likewise, an example of a hydrophobic sulfopolyester useful as a binder includes Eastek 1200® by EASTMAN. These two sulfopolyesters may be blended accordingly to optimize the water-permeability of the binder. Depending on the desired end use for the nonwoven article, the binder may be either hydrophilic or hydrophobic.

Undissolved or dried sulfopolyesters are known to form strong adhesive bonds to a wide array of substrates, including, but not limited to fluff pulp, cotton, acrylics, rayon, lyocell, PLA (polylactides), cellulose acetate, cellulose acetate propionate, poly(ethylene) terephthalate, poly(butylene) terephthalate, poly(trimethylene) terephthalate, poly(cyclohexylene) terephthalate, copolyesters, polyamides (e.g., nylons), stainless steel, aluminum, treated polyolefins, PAN (polyacrylonitriles), and polycarbonates. Thus, sulfopolyesters function as excellent binders for the nonwoven article. Therefore, our novel nonwoven articles may have multiple functionalities when a sulfopolyester binder is utilized.

The nonwoven article may further comprise a coating. After the nonwoven article and the optional binder dispersion are subjected to drying, a coating may be applied to the nonwoven article. The coating can comprise a decorative coating, a printing ink, a barrier coating, an adhesive coating, or a heat seal coating. In another example, the coating can comprise a liquid barrier and/or a microbial barrier.

After producing the nonwoven article, adding the optional binder, and/or after adding the optional coating, the nonwoven article may undergo a heat setting step comprising heating the nonwoven article to a temperature of at least 100° C., and more preferably to at least about 120° C. The heat setting step relaxes out internal fiber stresses and aids in producing a dimensionally stable fabric product. It is preferred that when the heat set material is reheated to the temperature to which it was heated during the heat setting step that it exhibits surface area shrinkage of less than about 10, 5, or 1 percent of its original surface area. However, if the nonwoven article is subjected to heat setting, then the nonwoven article may not be repulpable and/or recycled by repulping the nonwoven article after use.

The term “repulpable,” as used herein, refers to any nonwoven article that has not been subjected to heat setting and is capable of disintegrating at 3,000 rpm at 1.2 percent consistency after 5,000, 10,000, or 15,000 revolutions according to TAPPI standards.

In another aspect of the invention, the nonwoven article can further comprise at least one or more additional fibers. The additional fibers can have a different composition and/or configuration (e.g., length, minimum transverse dimension, maximum transverse dimension, cross-sectional shape, or combinations thereof) than the ribbon fibers and can be of any type of fiber that is known in the art depending on the type of nonwoven article to be produced. In one embodiment of the invention, the additional fiber can be selected from the group consisting cellulosic fiber pulp, inorganic fibers (e.g., glass, carbon, boron, ceramic, and combinations thereof), polyester fibers, nylon fibers, polyolefin fibers, rayon fibers, lyocell fibers, cellulose ester fibers, post-consumer ecycled fibers, and combinations thereof. The nonwoven article can comprise additional fibers in an amount of at least 10, 15, 20, 25, 30, 40, or 60 weight percent of the nonwoven article and/or not more than 99, 98, 95, 90, 85, 80, 70, 60, or 50 weight percent of the nonwoven article. In one embodiment, the additional fiber is a cellulosic fiber that comprises at least 10, 25, or 40 weight percent and/or no more than 80, 70, 60, or 50 weight percent of the nonwoven article. The cellulosic fibers can comprise hardwood pulp fibers, softwood pulp fibers, and/or regenerated cellulose fibers. In another embodiment, at least one of the additional fibers is a glass fiber that has a minimum transverse dimension of less than 30, 25, 10, 8, 6, 4, 2, or 1 microns.

The nonwoven article can further comprise one or more additives. The additives may be added to the wet lap of water non-dispersible microfibers prior to subjecting the wet lap to a wet-laid or dry-laid process. Additives include, but are not limited to, starches, fillers, light and heat stabilizers, antistatic agents, extrusion aids, dyes, anticounterfeiting markers, slip agents, tougheners, adhesion promoters, oxidative stabilizers, UV absorbers, colorants, pigments, opacifiers (delustrants), optical brighteners, fillers, nucleating agents, plasticizers, viscosity modifiers, surface modifiers, antimicrobials, antifoams, lubricants, thermostabilizers, emulsifiers, disinfectants, cold flow inhibitors, branching agents, oils, waxes, and catalysts. The nonwoven article can comprise at least 0.05, 0.1, or 0.5 weight percent and/or not more than 10, 5, or 2 weight percent of one or more additives.

Generally, manufacturing processes to produce nonwoven articles from multicomponent fibers can be split into the following groups: dry-laid webs, wet-laid webs, combinations of these processes with each other, or other nonwoven processes.

Generally, dry-laid nonwoven articles are made with staple fiber processing machinery that is designed to manipulate fibers in a dry state. These include mechanical processes, such as carding, aerodynamic, and other air-laid routes. Also included in this category are nonwoven articles made from filaments in the form of tow, fabrics composed of staple fibers, and stitching filaments or yards (should this be cards?) (i.e., stitchbonded nonwovens). Carding is the process of disentangling, cleaning, and intermixing fibers to make a web for further processing into a nonwoven article. The process predominantly aligns the fibers which are held together as a web by mechanical entanglement and fiber-fiber friction. Cards (e.g., a roller card) are generally configured with one or more main cylinders, roller or stationary tops, one or more doffers, or various combinations of these principal components. The carding action is the combing or working of the water non-dispersible microfibers between the points of the card on a series of interworking card rollers. Types of cards include roller, woolen, cotton, and random cards. Garnetts can also be used to align these fibers.

The multicomponent fibers in the dry-laid process can also be aligned by air-laying. These fibers are directed by air current onto a collector which can be a flat conveyor or a drum.

Wet laid processes involve the use of papermaking technology to produce nonwoven articles. These nonwoven articles are made with machinery associated with pulp fiberizing (e.g., hammer mills) and paperforming (e.g., slurry pumping onto continuous screens which are designed to manipulate short fibers in a fluid).

In one embodiment of the wet-laid process, multicomponent fibers are suspended in water, brought to a forming unit wherein the water is drained off through a forming screen, and the fibers are deposited on the screen wire.

In another embodiment of the wet-laid process, multicomponent fibers are dewatered on a sieve or a wire mesh which revolves at high speeds of up to 1,500 meters per minute at the beginning of hydraulic formers over dewatering modules (e.g., suction boxes, foils, and curatures). The sheet is dewatered to a solid content of approximately 20 to 30 percent. The sheet can then be pressed and dried.

The nonwoven article can be held together by 1) mechanical fiber cohesion and interlocking in a web or mat; 2) various techniques of fusing of fibers, including the use of binder fibers and/or utilizing the thermoplastic properties of certain polymers and polymer blends; 3) use of a binding resin such as a starch, casein, a cellulose derivative, or a synthetic resin, such as an acrylic copolymer latex, a styrenic copolymer, a vinyl copolymer, a polyurethane, or a sulfopolyester; 4) use of powder adhesive binders; or 5) combinations thereof. The fibers are often deposited in a random manner, although orientation in one direction is possible, followed by bonding using one of the methods described above. In one embodiment, the multicomponent fibers can be substantially evenly distributed throughout the nonwoven article.

The nonwoven articles also may comprise one or more layers of water-dispersible fibers, multicomponent fibers, or microdenier fibers.

The nonwoven articles may also include various powders and particulates to improve the absorbency of the nonwoven article and its ability to function as a delivery vehicle for other additives. Examples of powders and particulates include, but are not limited to, talc, starches, various water absorbent, water-dispersible, or water swellable polymers (e.g., super absorbent polymers, sulfopolyesters, and poly(vinyl alcohols)), silica, activated carbon, pigments, and microcapsules. As previously mentioned, additives may also be present, but are not required, as needed for specific applications.

### EXAMPLES

### Example 1

A sulfopolyester polymer was prepared with the following diacid and diol composition: diacid composition (71.5 mole percent terephthalic acid, 20.0 mole percent isophthalic acid, and 8.5 mole percent 5-(sodiosulfo) isophthalic acid) and diol composition (65 mole percent ethylene glycol and 35 mole percent diethylene glycol). The sulfopolyester was prepared by high temperature polyesterification under a vacuum. The esterification conditions were controlled to produce a sulfopolyester having an inherent viscosity of about 0.33. The melt viscosity of this sulfopolyester was measured to be in the range of about 6,000 to 8,000 poise at 240° C. and 1 rad/sec shear rate.

### Example 2

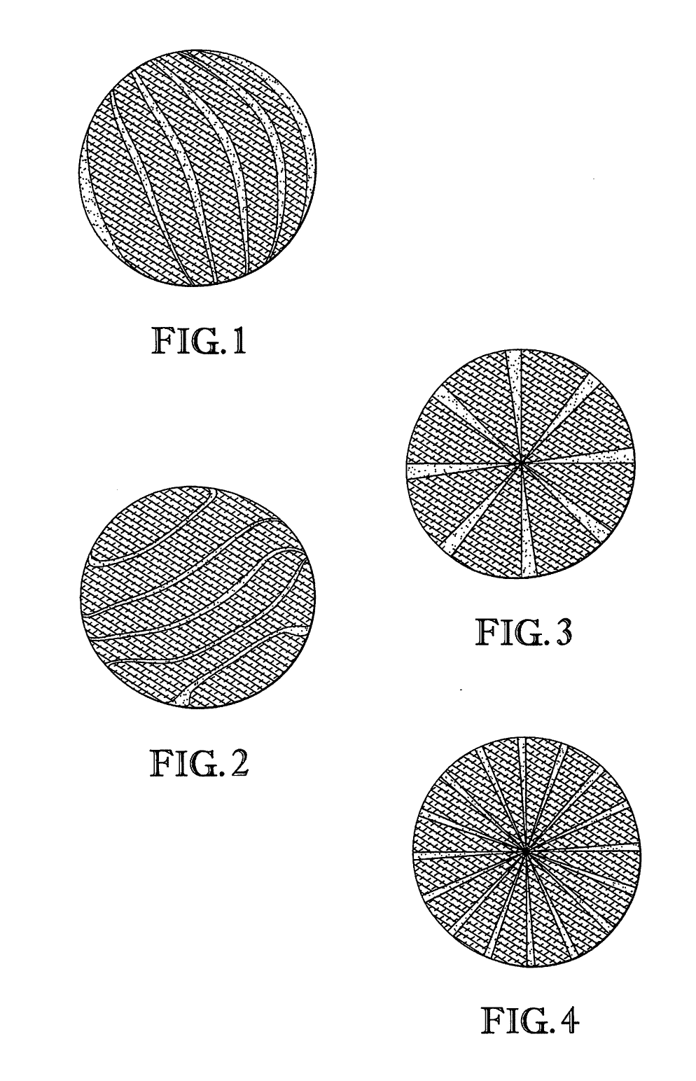

The sulfopolyester polymer of Example 1 and full dull 0.64 IV PET obtained from Nanya Plastics Corporation were spun into bicomponent “striped” cross-section fibers with 11 total stripes present in the cross-section as shown in FIGS. 1 and 2. The multicomponent fiber in FIG. 1 having five PET stripes is a comparative example in that it contains about 56.5% sulfopolyester on the perimeter of the multicomponent fiber (Five PET Stripe Multicomponent Fiber). The multicomponent fiber in FIG. 2 represents an embodiment of this invention containing six PET stripes with only 17.6% sulfopolyester on the perimeter of the multicomponent fiber (Six PET Stripe Multicomponent Fiber). In addition, the multicomponent fiber in FIG. 2 has PET stripes as the outer stripes rather than sulfopolyester as shown in FIG. 1.

These bicomponent fibers were spun using an extrusion temperature of 285° C. for the polyester component and 275° C. for the water dispersible sulfopolyester component. This bicomponent fiber contained a multiplicity of filaments (44 filaments) and was melt spun at a speed of about 1240 meters/minute, forming filaments with a nominal denier per filament of 5.3. The filaments of the bicomponent fiber were then drawn in line using a set of two godet rolls, heated to 80° C. and 125° C., respectively, and the final draw roll operating at a speed of about 3035 meters/minute to provide a filament draw ratio of about 2.45X, thus forming the drawn stripe bicomponent filaments with a nominal denier per filament of about 2.15. The drawn bicomponent fibers were then wound into bobbins, and then woven into fabric. The fabric was washed using soft water at 130° C. to remove the water dispersible sulfopolyester component, thereby releasing the “flat” or ribbon-shaped polyester microfibers component of the bicomponent fibers. The resulting microfibers were rinsed using soft water at 25° C. These filaments comprised essentially “flat” polyester microfibers having a transverse thickness of about 1.5 microns and an average transverse width of 10-12 microns.

### Example 3

A finish oil in a water emulsion was applied to the multicomponent fibers produced in Example 2. Testing was done with a range of Finish on Yarn (FOY) of 0.5 to 2 wt % of dry fiber. The FOY measurement can be made by extraction or NMR and is done commonly at most spinning manufacturing operations. It was found that the 5 Stripe PET Fiber of Example 2, which is a multi-component fiber having greater than 55% water dispersible polymer, in this case sulfopolyester, at the perimeter demonstrated significant fusing between the individual multicomponent fibers. This fusing created difficulties in winding and yarn handling as it was very difficult to get any air interlace into the bundle to promote bundle entanglement. Not being bound by theory, it was suspected that the sulfopolyester had interactions with the finish emulsion components that reduced the effective Tg of the sulfopolyester and promoted sticking or adhesion between adjacent multicomponent fibers where the sulfopolyester portion of the multicomponent fiber perimeters were in contact. The yarn was very dense due to the sticking between the individual multicomponent fibers, which resulted in very dense bobbins. A dense bobbin results in high contact between the fibers promoting sticking between the wraps on the bobbin. Measuring the unwind tension of these bobbins showed high tension that would increase as you went further into the bobbin. Thus, there was a tension profile as a bobbin was unwound starting low and increasing until the end of the bobbin was reached or the yarn broke. It was frequently found that the yarn broke before reaching the tube.

When similar testing was done with the multicomponent fiber of FIG. 2 (Six PET Stripe) having less than 55% of water dispersible polymer on the perimeter, it was found that the unwind tension was significantly more uniform with a minimal unwind profile for 6 stripe PET fibers produced with the same finish.

### Example 4

In any typical spinning process to create fiber and yarn, a finish oil is required for yarn lubrication and static control during processing. The finish is typically applied to the yarn in the process as an aqueous emulsion. For a fiber that contains a water dispersible component, the application of the water can create significant issues in processing as the yarn can absorb a portion of the water and become sticky. Further, it is possible that the components of the finish oil, such as emulsifiers, can interact with the water dispersible polymer and further create sticking and poor performance.

As an example, a comparison was made between bobbins produced with a 5 Stripe PET cross section (FIG. 1) and a 6 Stripe PET cross section (FIG. 2). The aqueous finish emulsion comprised a 10% oil emulsion using Lurol® 748 (Goulston Technologies). The finish emulsion was applied at a rate such that the amount of oil on the dry yarn would be -1.5% by weight.

Each bobbin type was placed on a creel, and the yarn was unwound with a pneumatic air jet. An assessment was then made as to whether the yarn was successfully removed from the bobbin. Results are shown in Table 1. The values in the table indicate that none of the bobbins made as FIG. 1 (Five Stripe PET Multicomponent Fiber) would unwind completely without breaking, whereas all of the bobbins made as FIG. 2 (Six Stripe PET Multicomponent Fiber) were completely removed. This demonstrates that the higher percentage of water dispersible polymer on the perimeter of bobbins made as FIG. 1 resulted in a more sticky yarn and was not suitable for downstream processing into fabrics.

TABLE 1

| | % bobbins with |
|---|---|
| Bobbin | full yarn removal |
| Five Stripe Multicomponent | 0 |
| Fiber (FIG. 1) | |
| Six Stripe Multicomponent | 100 |
| Fiber (FIG. 2) | |

It is known the bobbins produced with the 5 Stripe PET cross section multicomponent fiber must be stored below a range of temperature and relative humidity (RH %) or it promotes sticking within the bobbin and created significant unwinding problems. Since the sulfopolyester is hydrophilic, it can tend to absorb moisture from the environment which can lower the Tg (glass transition temperature) and can promote sticking between the wound fibers in the bobbin. The Tg of a water dispersiblepolymer can be greatly impacted by the RH % of the environment. It has been found that the inventive Six PET stripe cross section multicomponent fiber having less exposed sulfopolyester and thus less contact points of the sulfopolyester component between adjacent multi-component fibers is less sensitive to this phenomenon.

### Example 5

The water dispersible component of a multicomponent fiber may have higher friction properties than the water non-dispersible polymer component. The Five Stripe Pet Multicomponent Fiber shown in FIG. 1 was found to show higher frictional properties than the Six Stripe Multicomponent Fiber of Example 2 and shown in FIG. 2 as demonstrated by measuring the force required to pull a yarn through a length of tubing. Minimizing the amount of sulfopolyester on the surface of the multicomponent fiber reduced this frictional force component and allowed the multicomponent fiber to perform more like a typical mono component fiber.

The amount of frictional wear a yarn creates on a surface is important to the cost and reliability of the downstream processing of the yarn to form fabric constructions. To evaluate the frictional wear performance of a yarn, an abrasion test was run. The instrument used was a CTT-E Model LH-450 instrument manufactured by Lawson Hemphill Inc. (Swansea, Massachusetts) which is a common instrument used by the industry for measuring yarn properties. In this test, the yarn is pulled against a standardized copper wire, and the number of cycles required to cut through the wire are recorded.

Using this apparatus, a comparison was made between bobbins produced with a “5 stripe” cross section (FIG. 1) and a “6 stripe” cross section (FIG. 2) produced in Example 2.

Table 2 shows the recorded number of cycles required for each product type to cut through the wire. Note that the 5 Stripe Multicomponent Fiber with the higher percentage of water dispersible polymer on the perimeter required significantly less cycles to cut the wire indicating a higher frictional wear yarn.

TABLE 2

| | Number of Cycles |
|---|---|
| Bobbin | for wire breakage |
| Six Stripe Multicomponent | 424 |
| Fiber(Ex. 2) | |
| Five Stripe Multicomponent | 508 |
| Fiber (Ex. 2) | |

### Example 6

Two typical ways to create multicomponent melt spun fiber are the FDY (fully drawn yarn) and the POY/DTY (partially oriented yarn followed by draw & texturizing) spinning processes. These are commonly practiced spinning processes known in the art.

In general, the FDY process consists of conditioning the polymer materials (typically by drying), melting the polymers using some type of screw extruder, metering and combining the melts of the different components in a spin pack that has a design to selectively meter the polymers as needed to each spin orifice to create the target cross sectional geometry, extruding the multi-component melt through a series of spin holes, quenching and spin drawing the fiber, processing the fiber over a series of heated rolls to prepare the fiber for a hot draw, then hot drawing between a pair of rolls, followed by the heat treatment of the fully drawn yarn, interlacing the yarn (if desired), and finally winding the yarn into a bobbin. Note in the FDY process, the wound bobbin is the final yarn product and is ready for downstream conversion into an article.

In general, the POY is similar to the FDY process until the melt is extruded from the spin pack. In POY, essentially all of the process draw occurs between the pack and the first set of draw rolls. This creates some orientation in the yarn, but it is not fully drawn and there is no heat set—so the yarn has minimal crystallinity. The POY yarn has a higher Elongation-to-Break percentage and a lower tenacity than a FDY yarn. This POY yarn will be drawn, possibly textured and heat set in a separate process. Note that there is no drying step in the typical POY spinning process, so the yarn will be wound with a much higher moisture content that the FDY yarn.

The comparative 5 stripe PET cross section multicomponent fiber having about 56.5% sulfopolyester on the fiber surface perimeter was found to be very sensitive to the spin process conditions. Althought not wishing to be bound by theory, as the fiber is exposed to the finish emulsion and then heated to prepare for the drawing step, there may be a competition between the evaporation of the water applied in the finish emulsion and the diffusion of the water into the water dispersible polymer component. It was found that the 5 PET stripe multicomponent fiber was very sensitive to the temperature of the rolls and it was possible to diffuse enough water into the sulfopolyester prior to the water evaporating to create fiber sticking and winding problems.

In the POY spinning process, it was found the 5 PET stripe cross section multicomponent fiber had two additional issues. First, the sulfopolyester component contributed little to the overall fiber strength (strength is mostly carried by the water non-dispersible polymer component) but it does contribute to the multicomponent fiber mass. At the typical winding speeds for a POY spinning process (range of 3000-3600 mpm), it was found that the low strength of the multicomponent POY fiber combined with the high mass caused the fiber to deform while being wound which destabilized the winding and caused breaks. Second, the high moisture of the wound POY fiber interacted with the sulfopolyester on the surface of the fibers and created significant amounts of sticking which prevented uniform unwinding.

The 6 PET stripe cross section multicomponent fiber having about 17.6% sulfopolyester on the fiber surface perimeter was found to be much less sensitive to the process conditions and had much reduced problems with sticking and winding. The 6 PET stripe cross section multicomponent fiber performed well in the POY spinning process as the reduced amount of sulfopolyester contributed less to the fiber mass. Further, the 6 PET stripe cross section multicomponent fiber did not appear to demonstrate significant sticking with the higher amount of moisture present in the POY bobbins. It was found that doing some drying of a POY yarn that contained the water dispersible polymer component before winding can be possibly advantageous for extending the shelf life of the multicomponent POY bobbin.

### Example 7

Another example of a cross section that can be used in this invention is the segmented pie cross section. In this cross section, the water dispersible and non-water dispersible polymers are alternately arranged in wedge shapes symmetrically around the fiber center. In addition, it may be desirable to distribute the polymers such that there is some additional amount of the water dispersible polymer provided to the center of the multi-component fiber to promote the separation of the wedges during the removal of the water dispersible component.

The sulfopolyester polymer of Example 1 and Nanya® full dull 0.64 IV PET were spun into segmented pie bicomponent cross-section fibers with 32 total segments present in the cross-section as shown in FIG. 4. 16 of the segments were comprised of the sulfopolyester and 16 segments were comprised of the Nanya® PET. The ratio of the Nanya® PET to the sulfopolyester comprising the fiber was 85:15, and the segments were distributed in a symmetric arrangement, thus no more than 15% of the outer perimeter of the fiber was comprised of the sulfopolyester. Some amount of sulfopolyester was distributed to the center of the fiber (˜10% of total sulfopolyester feed). The cross section of this example is shown in FIG. 4. These bicomponent fibers were spun using an extrusion temperature of 285° C. for the Nanya® polyester component and 275° C. for the water dispersible sulfopolyester component. The continuous spun bicomponent yarn contained a multiplicity of filaments (40 filaments—each filament with the 32 segments) and was melt spun at a speed of about 1015 meters/minute, forming filaments with a nominal denier per filament of 7.4. The filaments of the bicomponent fiber were then drawn in line using a set of two godet rolls, heated to 85° C. and 125° C., respectively, and the final draw roll operating at a speed of about 3030 meters/minute to provide a filament draw ratio of about 2.9×, thus forming the drawn segmented pie bicomponent filaments with a nominal denier per filament of about 2.5. The drawn bicomponent fibers were then heat set and wound into bobbins. Once the sulfopolyester is removed in downstream processing the resulting individual segments of PET would be approximately 0.13 dpf.

### Comparative Example 8

Numerous attempts to texturize samples of highly oriented (HOY) six stripe bicomponent “striped” cross-section fibers or filaments (FIG. 2) were attempted over the course of 5 to 6 hours, but it was difficult to thread-up (or simply run) the bicomponent fiber through a friction disk draw texture machine. The friction disk draw machine had the following elements: first heating zone having a heating element 3 meters long and a temperature of 180° C., a twisting unit and a cooling zone; second heating zone having a heating element, and an overfeed shaft. Various combinations of input feed yarn, draw ratios, speeds, and D/Y ratios were evaluated. In each case, the yarn would break before the twisting unit and never reach the second heater or overfeed shaft. The temperature of the first heating element was set to 180° C., a temperature conventionally used for standard polyester yarn. It was noted that the filaments were very brittle and sometimes fused together when they came out of the first heating element, and it was not possible to texturize the fibers or was not able to make a yarn.

### Example 9

Additional attempts to texturize samples of highly oriented (HOY) bicomponent “striped” cross-section fibers were attempted using the process described in Comparative Example 1, except that the first heating element was operated at a lower temperature of about 85° C. in the first zone. In this example, the 3-meter long heater was incapable of maintaining the lower temperature, so a different electric 1-meter long heater was used with the yarn moving at 500 m/min. The starting fibers were run through the system to produce good yarn by setting the heater in the first zone to about 85° C.

### Example 10

After determining that good textured yarn could be produced using the lower heater temperature in the first zone, additional starting yarn was texturized. Multiple bobbins of yarn were produced by running the starting yarn packages at different conditions. Many samples of six strip bicomponent “striped” cross-section fibers (FIG. 2) produced were then evaluated to determine the amount or range of texturization. The samples were produced by varying parameters such as input feed (denier, cross section, % sulfopolyester component, % FOY, and elongation), stabilizer (or overfeed shaft draw), D/Y ratio, disk configuration, disk material, % take-up (overfeed shaft to bobbin speed), draw ratio, primary heater temperature and godet temperature.

The first heating element was varied from 85 to 120° C. The second heating element was varied from 75 to 110° C. Draw ratio was varied from just over 1.0 to just over 2.0, D/Y ratio varied from about 1.7 to 4.0, and denier of the feed yarn varied from about 140 to just over 260. Feed yarn used was either FDY or POY yarn. Details of the heater temperatures, type of starting yarn, draw ratio and D/Y ratio conditions used to produce the yarn are shown in the Table 3.

TABLE 3

| | | | First | | Second |
|---|---|---|---|---|---|
| | Type | Draw | Heater | D/Y | Heater |
| 1 | FDY | 1.06 | 85 | 2.7 | 75 |
| 2 | FDY | 1.02 | 85 | 2.7 | 75 |
| 3 | FDY | 1.06 | 85 | 1.7 | 85 |
| 4 | POY | 1.13 | 85 | 2.7 | 75 |
| 5 | POY | 1.2 | 85 | 2.7 | 95 |
| 6 | POY | 1.2 | 90 | 2.7 | 75 |
| 7 | POY | 1.2 | 95 | 2.7 | 75 |
| 8 | POY | 1.2 | 100 | 2.7 | 75 |
| 9 | POY | 1.2 | 100 | 2.7 | 105 |
| 10 | POY | 1.2 | 110 | 2.7 | 95 |
| 11 | POY | 1.2 | 115 | 2.7 | 95 |
| 12 | POY | 1.2 | 115 | 2.7 | 95 |
| 13 | POY | 1.2 | 120 | 2.7 | 75 |
| 14 | POY | 1.2 | 85 | 2.7 | 95 |
| 15 | POY | 1.33 | 85 | 2.7 | 75 |
| 16 | POY | 1.43 | 85 | 2.7 | 75 |
| 17 | POY | 1.43 | 85 | 2.7 | 95 |
| 18 | POY | 1.43 | 85 | 2.7 | 110 |
| 19 | POY | 1.43 | 110 | 2.7 | 95 |
| 20 | POY | 1.43 | 85 | 2.7 | 75 |
| 21 | POY | 1.43 | 85 | 2.7 | 95 |
| 22 | POY | 1.43 | 85 | 2.7 | 110 |
| 23 | POY | 1.43 | 90 | 2.7 | 75 |
| 24 | POY | 1.43 | 95 | 2.7 | 75 |
| 25 | POY | 1.43 | 100 | 2.7 | 75 |
| 26 | POY | 1.43 | 100 | 2.7 | 105 |
| 27 | POY | 1.43 | 110 | 2.7 | 95 |
| 28 | POY | 1.43 | 120 | 2.7 | 75 |
| 29 | POY | 1.62 | 85 | 2.7 | 75 |
| 30 | POY | 1.62 | 85 | 2.7 | 95 |
| 31 | POY | 1.62 | 85 | 2.7 | 110 |
| 32 | POY | 1.62 | 100 | 2.7 | 75 |
| 33 | POY | 1.62 | 110 | 4 | 110 |
| 34 | POY | 2.02 | 85 | 2.7 | 95 |
| 35 | POY | 2.02 | 85 | 2.7 | 110 |
| 36 | POY | 2.02 | 90 | 2.7 | 75 |
| 37 | POY | 2.02 | 95 | 2.7 | 75 |
| 38 | POY | 2.02 | 100 | 2.5 | 75 |
| 39 | POY | 2.02 | 100 | 3.5 | 75 |
| 40 | POY | 2.02 | 110 | 2.5 | 110 |
| 41 | POY | 1.4 | 100 | 4 | 110 |

All of the conditions shown in Table 3 produced yarn suitable for further processing into fabric or other materials.

### Example 11

After running the tests as described in Example 10, additional six stripe bicomponent fiber (FIG. 2) was textured in the friction disk process of the invention at a selected set of conditions to produce about 120 bobbins of yarn for further use (such as in knitting, weaving, covering, and the like). The friction disk machine was a SSM model RG12DTB using 1-6-1 ceramic friction disks and a one-meter primary heater in the primary heating zone. The primary heater temperature was set to 100° C., and the processing speed was about 800 m/min. The secondary heating zone used a godet roll set to a temperature of 110° C. The DN ratio (circumferential speed of disks/throughput of yarn) was about 4.0, and the draw ratio was about 1.4. Using these conditions, acceptable textured yarn was produced for further processing into fabric or other materials.

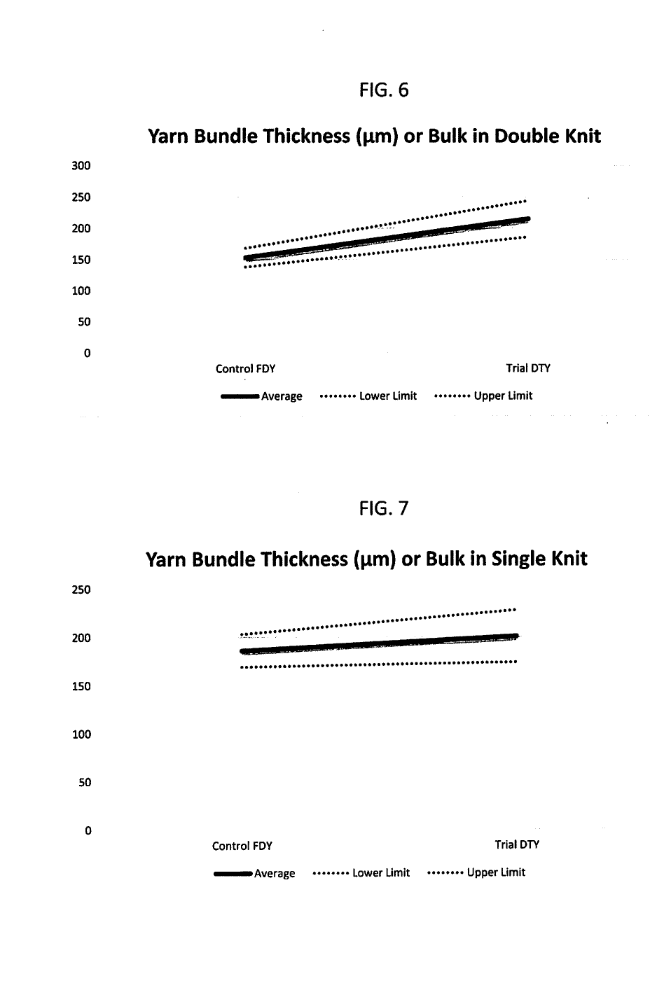

As shown and described above, using the texturizing process of the present invention provides yarn that is thicker or bulkier than yarn from non-texturized yarn processes. Further, using the texturizing process of the present invention with a multi-component fiber as described provides a thicker or bulkier yarn than standard polyester yarns. As shown in the graphs in FIGS. 6 and 7, the yarns that are texturized using the friction disk process of the invention are thicker or bulkier than those that are not texturized using the inventive process. As shown in FIG. 6, the texturized fibers from the process of the invention in a double-knit configuration have about 41% more thickness than the same type of yarn or fibers that are fully drawn but not texturized. While single knit allows both yarn bundles to thicken, as shown in FIG. 7, the texturized fibers from the process of the invention in a single knit configuration have about 8% more thickness than the control yarn or fibers which are fully drawn but not texturized.

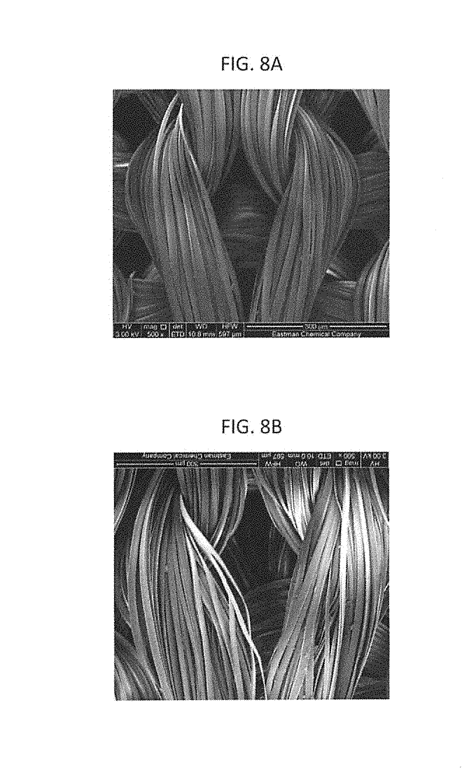

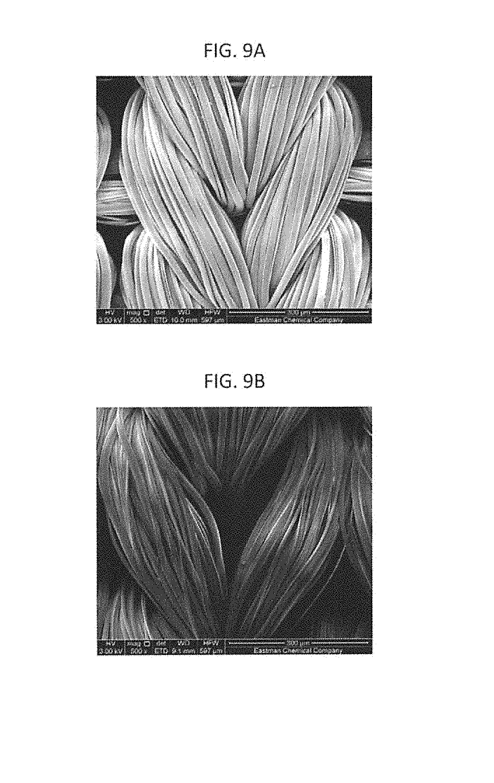

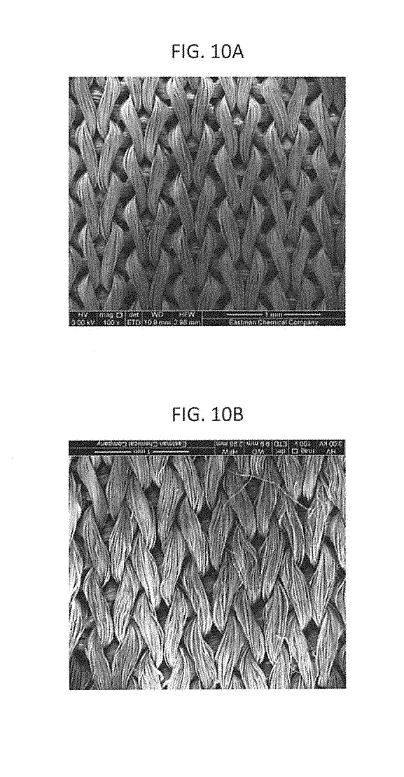

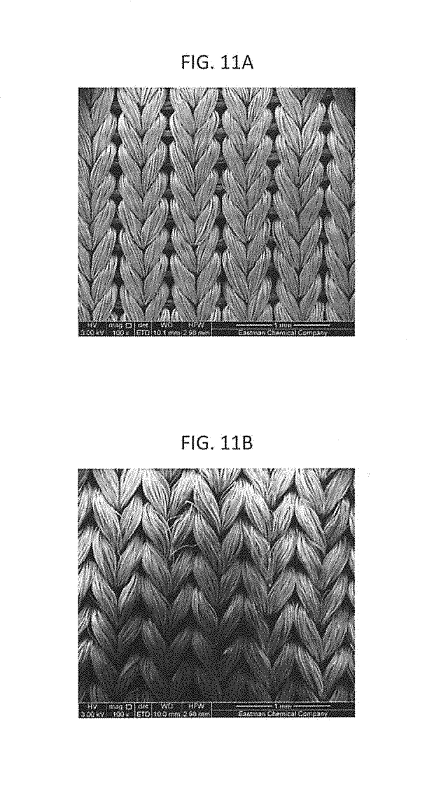

FIGS. 8A and 8B visually depict the yarns that are shown in FIG. 6 in double knit interlock construction. The pictures were taken at 500× magnification. As shown in FIG. 8B, the yarn texturized using the process of the invention is thicker or bulkier than the fully drawn yarn (FDY). FIGS. 9A and 9B visually depict the yarns that are shown in FIG. 7 in single knit jersey construction. The pictures were taken at 500× magnification. As shown in FIG. 9B, the yarn of the invention is thicker or bulkier. FIGS. 10A, 10B, 11A and 11B show the same yarns at 100× magnification.

What is claimed is:

1. A process for making a multicomponent fiber comprising:
extruding at least one water dispersible polymer to create a first polymer flow,
extruding at least one water non-dispersible synthetic polymer to create a second polymer flow path,
directing the resulting multiple polymer flows into a spinneret having a shaped cross section with a plurality of distribution flow paths, and combining the flow paths together to form a multicomponent fiber having a shaped cross section, wherein the multicomponent fiber comprises:
(A) at least one water dispersible polymer; and
(B) a plurality of domains comprising one or more water non--dispersible polymers, wherein the domains are substantially isolated from each other by the water dispersible polymer intervening between the domains; and
wherein the water dispersible polymer is present at the perimeter of the outside cross-section of the multicomponent fiber in a proportion of no greater than 55% water dispersible polymer.

2. The process of claim 1, wherein the water dispersible polymer is a water dispersible sulfopolyester.

3. The process of claim 1, wherein the water dispersible polymer is present at the perimeter of the outside cross-section of the multicomponent fiber in a proportion selected from no greater than 50% water dispersible polymer, no greater than 45%, no greater than 40%, no greater than 35%, and no greater than 30%.

4. The process of claim 1, further comprising drawing the multicomponent fiber, texturing the multicomponent fiber or a combination of drawing and texturing the multicomponent fiber.

5. The process of claim 4, wherein the texturing is selected from the group consisting of friction disk texturing, air jet texturing, stuffer box texturing, knife edge texturing and a combination thereof.

6. The process of claim 1, further comprising quenching the multicomponent fiber thereby solidifying the multicomponent fiber.

7. The process according to claim 1, further comprising applying at least one finish to the multicomponent fiber.

8. A process for making a multicomponent fiber comprising:
melt spinning at least one water dispersible polymer and at least one water non-dispersible polymer through a shaped cross section to form a multicomponent fiber having a shaped cross section,
wherein the multicomponent fiber comprises a plurality of domains comprising the at least one water non-dispersible polymer that are substantially isolated from each other by the water dispersible polymer intervening between the domains; and wherein the water dispersible polymer is present at the perimeter of the outside cross-section of the multicomponent fiber in a proportion of not greater than 55% water dispersible polymer.

9. The process of claim 8, wherein the water dispersible polymer is present at the perimeter of the outside cross-section of the multicomponent fiber in a proportion selected from no greater than 50% water dispersible polymer, no greater than 45%, no greater than 40%, no greater than 35%, and no greater than 30%.

10. The process of claim 8 further comprising drawing the multicomponent fiber, texturing the multicomponent fiber or a combination of drawing and texturing the multicomponent fiber.

11. The process of claim 10, wherein the texturing is selected from the group consisting of friction disk texturing, air jet texturing, stuffer box texturing, knife edge texturing and a combination thereof.

12. The process of claim 8, further comprising quenching the multicomponent fiber thereby solidifying the multicomponent fiber.

13. The process according to claim 8, further comprising applying at least one finish to the multicomponent fiber.

14. A process for producing at least one multicomponent fiber having a shaped cross section comprising:
spinning at least one water dispersible sulfopolyester having a glass transition temperature (Tg) of at least 25° C. and at least one water non-dispersible polymer into said multicomponent fiber, said water dispersible polymer comprising:
(i) about 50 to about 96 mole percent of one or more residues of isophthalic acid and/or terephthalic acid, based on the total acid residues;
(ii) about 4 to about 30 mole percent, based on the total acid residues, of a residue of sodiosulfoisophthalic acid;
(iii) one or more diol residues, wherein at least 25 mole percent, based on the total diol residues, is a poly(ethylene glycol) having a structure H—(OCH₂—CH₂)ₙ—OH wherein n is an integer in the range of 2 to about 500; and
(iv) 0 to about 20 mole percent, based on the total repeating units, of residues of a branching monomer having 3 or more functional groups wherein the functional groups are hydroxyl, carboxyl, or a combination thereof;
wherein said multicomponent fiber has a plurality of segments comprising said water non-dispersible polymer and said segments are substantially isolated from each other by said sulfopolyester intervening between said segments,
wherein the water dispersible polymer is present at the perimeter of the outside cross-section of the multicomponent fiber in a proportion of no greater than 55% water dispersible polymer and
optionally, wherein said multicomponent fiber contains less than 10 weight percent of at least one pigment or filler, based on the total weight of said multicomponent fiber.

15. The process of claim 14, wherein the water dispersible polymer is present at the perimeter of the outside cross-section of the multicomponent fiber in a proportion selected from no greater than 50% water dispersible polymer; no greater than 45%, no greater than 40%, no greater than 35%, and no greater than 30%.

16. The process of claim 14, further comprising drawing the multicomponent fiber, texturing the multicomponent fiber or a combination of drawing and texturing the multicomponent fiber.

17. The process of claim 16 wherein the texturing is selected from the group consisting of friction disk texturing, air jet texturing, stuffer box texturing, knife edge texturing and a combination thereof.

18. The process of claim 14, further comprising quenching the multicomponent fiber thereby solidifying the multicomponent fiber.

19. The process according to claim 14, further comprising applying at least one finish to the multicomponent fiber

20. The process of claim 14, wherein said multicomponent fiber has an as-spun denier of less than about 15 denier per filament.
